(19) United States
(12) Patent Application Publication
(10) Pub. No.: US 2015/0197958 A1
(43) Pub. Date: Jul. 16, 2015

(54) RETAINING SYSTEM

(71) Applicant: FAS Wilson Pty Ltd, Armadale (AU)

(72) Inventor: Malcolm Wilson, Malvern East (AU)

(73) Assignee: FAS Wilson Pty Ltd., Armadale (AU)

(21) Appl. No.: 14/421,741

(22) PCT Filed: Aug. 1, 2013
(86) PCT No.: PCT/AU2013/000847

§ 371 Date: Feb. 13, 2015

(30) Foreign Application Priority Data
Aug. 17, 2012 (AU) 2012903571

(51) Int. Cl. E04H 17/10; A01K 3/00; E04H 17/14; E04H 17/20; E04H 17/02; E04H 17/06

(52) U.S. Cl. CPC E04H 17/10; E04H 17/02; E04H 17/06; E04H 17/14; E04H 17/20; A01K 3/005; E04H 2017/1447

(57) ABSTRACT

Embodiments of the invention relate to the retention of fence mesh, fence wires and flexible screens to stakes, pickets and the like and which avoid the need for individual ties. In particular, in some embodiments the retention effect is provided by a slotted tube engaged around the stake or picket to provide retention over the full height of the stake or picket. In other embodiments the stake or picket is slotted to receive fence wires or the wires of fence mesh with locking means applied to the picket or stake to retain the wires in the slots.

The present invention relates to a system for retaining barriers, fences, screens and the like of flexible material or for retaining wire fences.

Lengths of flexible fence, barrier, or screen material are typically retained in position by attachment to pickets or stakes driven into the ground and to which the material is attached usually by means of ties. One example of this is the use of orange or other high visibility plastic safety fence mesh for temporarily blocking access to construction zones and the like. Not only is it a relatively time-consuming exercise to attach material to the pickets or stakes driven into the ground, the fence material is rarely installed under sufficient tension to avoid sagging but even if care is taken the retention may not be particularly satisfactory and the fence mesh does tend to slip and sag over time. Similar methods are often used for installing flexible advertising signs, wind barriers and silt fences for erosion control where functionality may be seriously compromised through the material not being retained in a satisfactory manner.

The present invention in certain of its preferred embodiments provides a retention system which is easily and quickly applied and has the ability to anchor such fence, barrier, or screen material firmly against a picket or stake over the full height of the material.

The present invention in others of its preferred embodiments relates to fence posts or droppers having facility for quick and easy attachment by wires of a wire mesh fence or wire fence.

According to one aspect of the present invention there is provided a retention system comprising a tube adapted to be fitted over a picket or stake for retaining relative to the picket or stake flexible fence, barrier, screen material or the like, the wall of the tube including a slot extending longitudinally of the tube over at least part of its length, the slot being open at its lower end and being shaped at its lower end to provide a convergent mouth which leads into the slot to facilitate entry into the slot of flexible material against a side of the picket or stake remote from the slot when the tube is moved downwardly over the picket or stake whereby the tube acts to anchor the flexible material against the picket or stake.

Another aspect of the invention provides an adaptation of the retention system for use with wire mesh fence or wire fence.

According to this other aspect there is provided a retention system comprising a tube for use in conjunction with a picket or stake for retaining horizontal wire runs of fencing wire or wire fence mesh, the tube having a slot extending longitudinally along at least part of its length, the slot opening to the lower end of the tube, the tube having a series of transverse slots opening onto the longitudinal slot at each edge thereof, the transverse slots being longitudinally-spaced whereby when the tube is applied to a picket or stake the transverse slots extend horizontally to receive the horizontal wire runs.

According to another aspect of the invention, there is provided a post for a fence consisting of horizontal runs of fencing wire or of wire fence mesh, the post having along its length vertically-spaced horizontal slots each serving to receive a fencing wire by lateral movement of the wire into the slot, and means for retaining the wires within the slots.

According to yet another aspect of the invention, there is provided a dropper for mounting on horizontal wire runs of fencing wire between fence posts to maintain the runs in spaced relation, the dropper comprising a member having along its length vertically-spaced horizontal slots each serving to receive a fencing wire by lateral movement of the wire into the slot, and means for retaining the wires within the slots and for anchoring the member to the wire to prevent movement of the member along the wire.

According to yet another aspect of the invention, there is provided a post for retaining horizontal wire runs of fencing wire or of wire fence mesh, the post having a longitudinally-extending formation with longitudinally-spaced slots for receiving the wires by lateral insertion of the wires into the slots, and means engageable over the formation after engagement of the wires within the slots to retain wires within the slots.

According to yet another aspect of the invention, there is provided a post for retaining horizontal wire runs of fencing wire or of wire fence mesh, the post being in the form of a stake or picket having a cross-sectional configuration formed by a plurality of legs, wherein one of the legs is formed with vertically-spaced generally horizontal slots opening to an outer edge of the leg for receiving the horizontal wire runs, and means engageable over the outer edge of the leg for retaining the wires within the slots.

According to yet another aspect of the invention, there is provided a bollard comprising a base for standing on a solid surface and carrying a picket or stake for use with a retention system as described above.

Embodiments of the invention will now be described by way of example only with reference to the accompanying drawings in which:

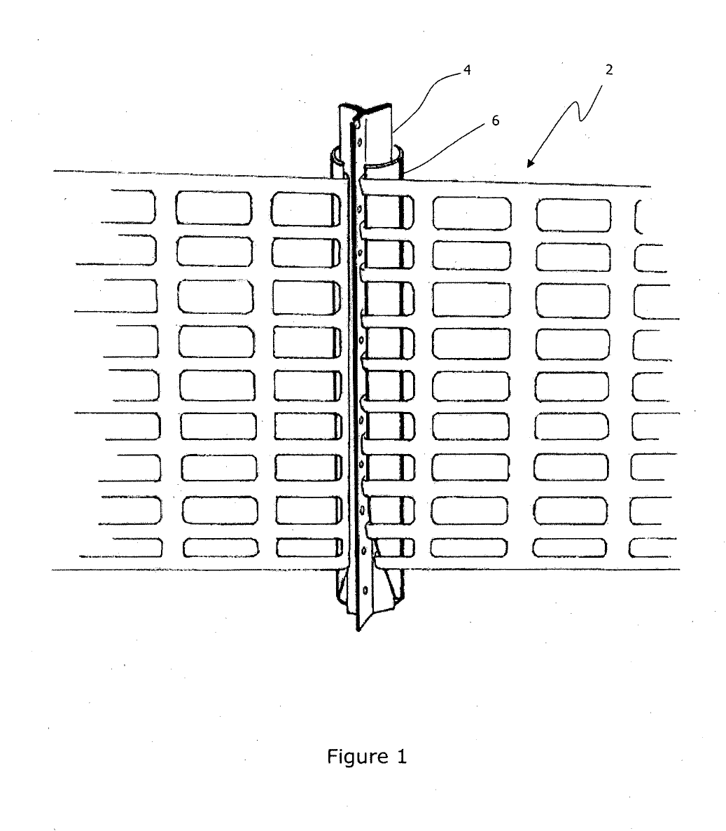

FIG. 1 is a view showing plastic fence mesh retained to a picket by a retaining system in accordance with one embodiment of the invention;

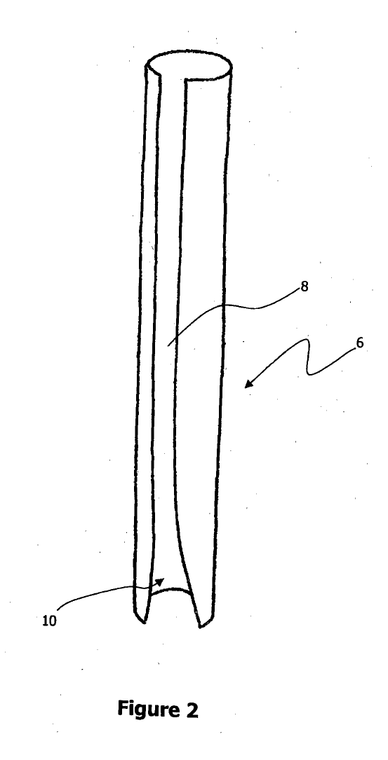

FIG. 2 shows a retaining tube of the system;

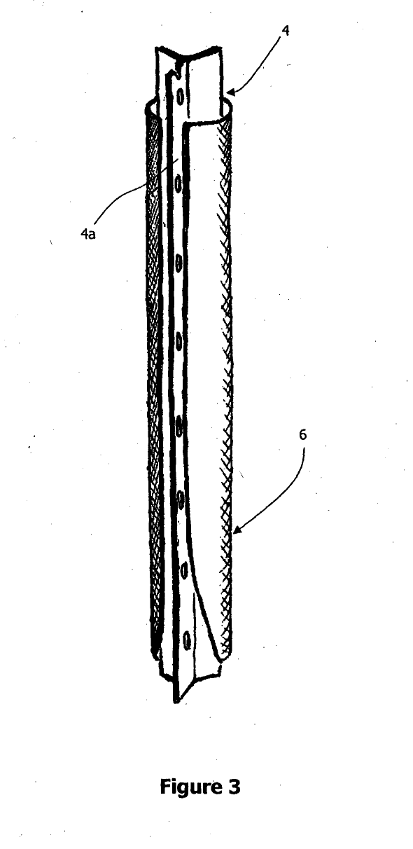

FIG. 3 shows the interaction between the retaining tube and the picket;

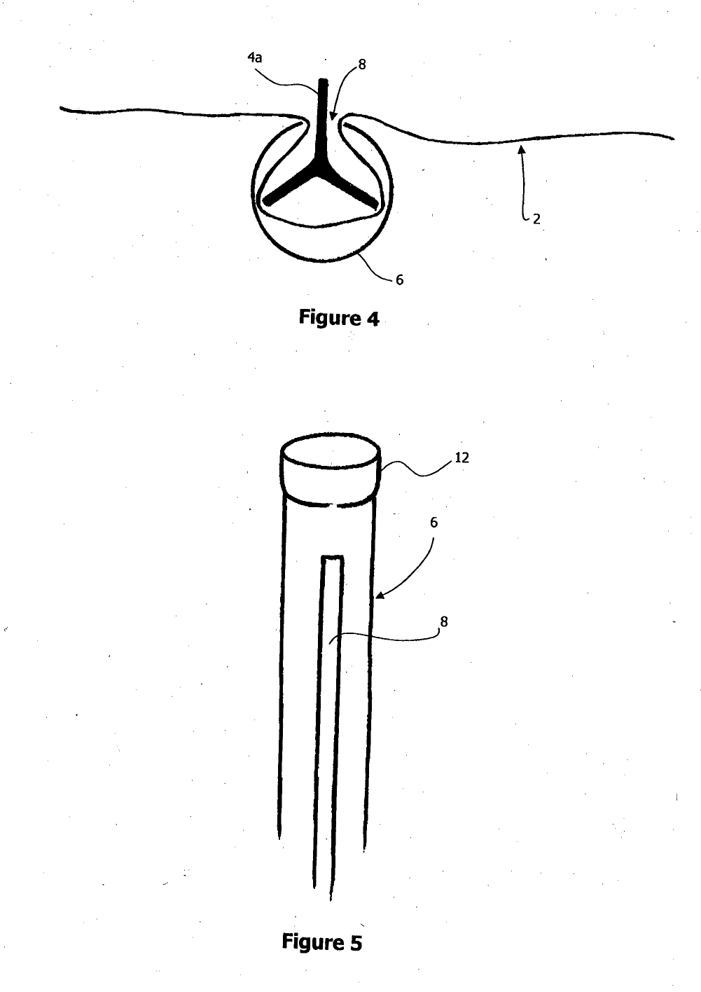

FIG. 4 is a schematic horizontal section showing the manner in which the plastic fence mesh is applied around the picket by the application of the retaining tube;

FIG. 5 is a fragmentary view of the upper part of a modified form of the tube;

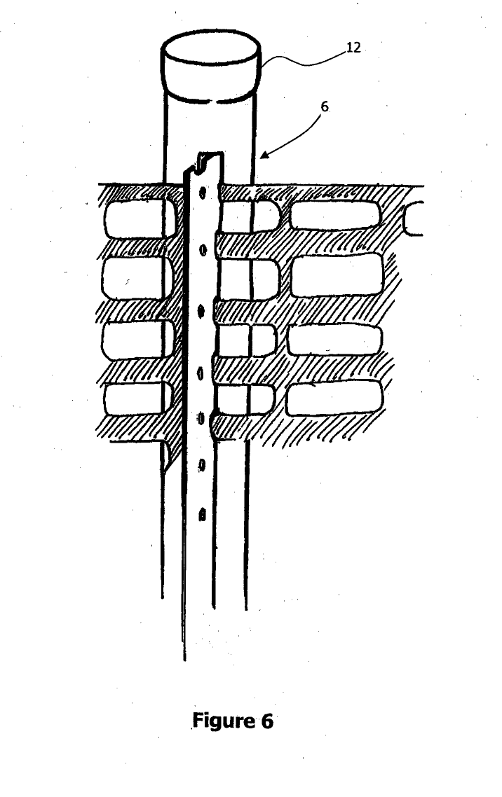

FIG. 6 is a view similar to that of FIG. 5 but showing the tube applied to the picket to retain the fence mesh;

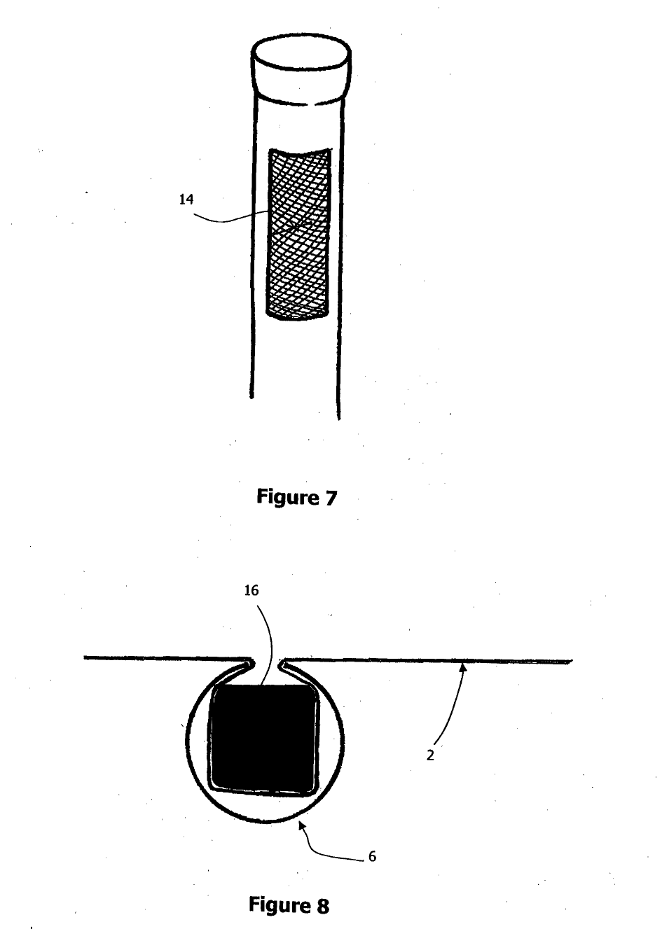

FIG. 7 is a view similar to FIG. 5 but of the opposite side of the tube;

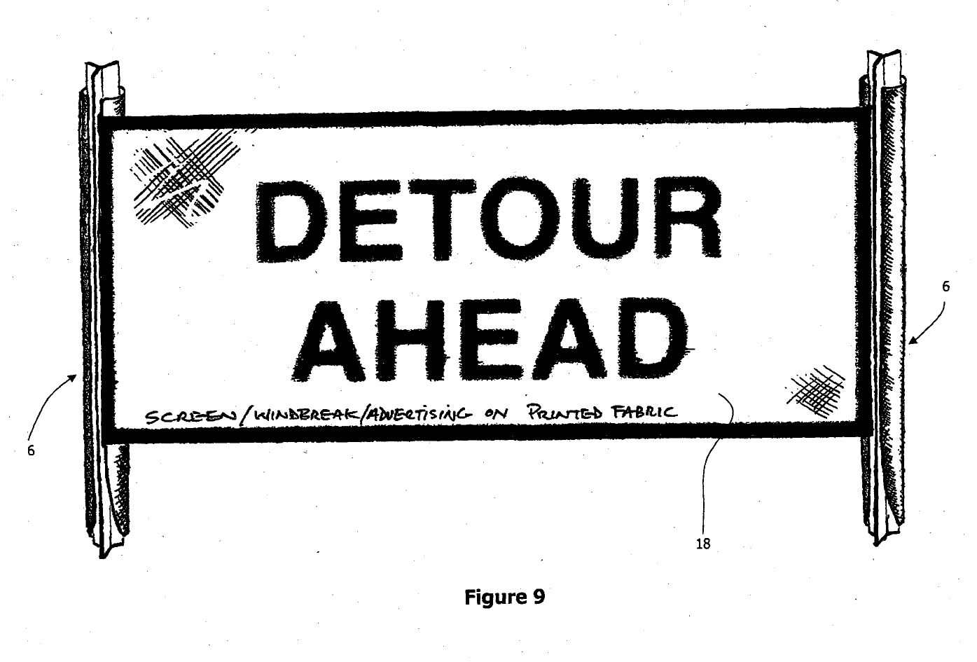

FIG. 8 is a schematic horizontal section similar to FIG. 4 but showing the interaction with a square-section stake;

FIG. 9 is a view showing how the retaining system can be used to anchor opposite ends of flexible sheet material as may be used to form a warning sign, screen, barrier or the like;

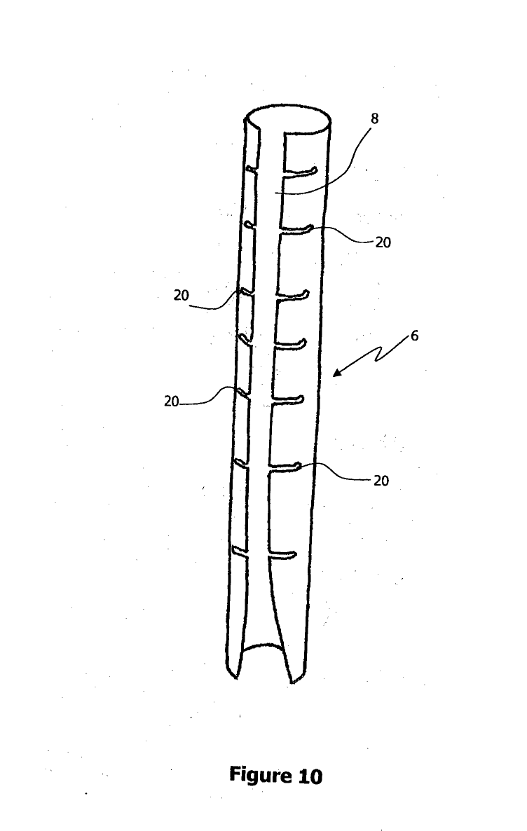

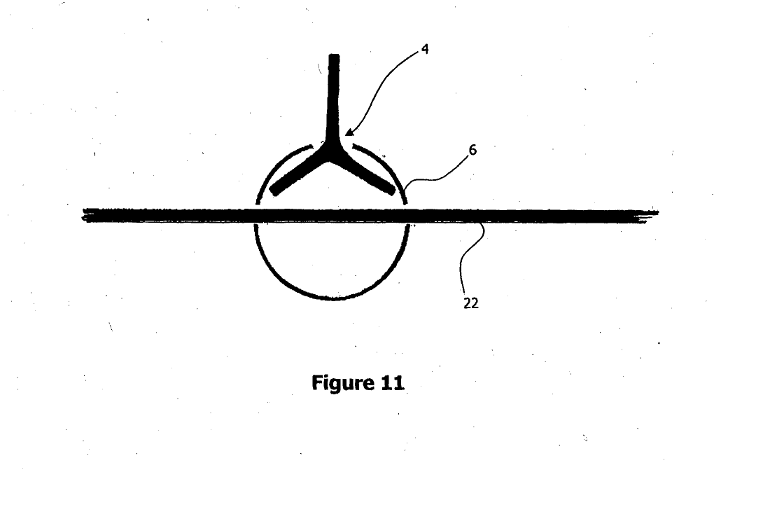

FIG. 10 shows a modified form of retaining tube for use with wire mesh fence or wire fence;

FIG. 11 is a schematic horizontal section illustrating how the retaining tube of FIG. 10 acts in conjunction with a picket to retain a horizontal wire course of a fence;

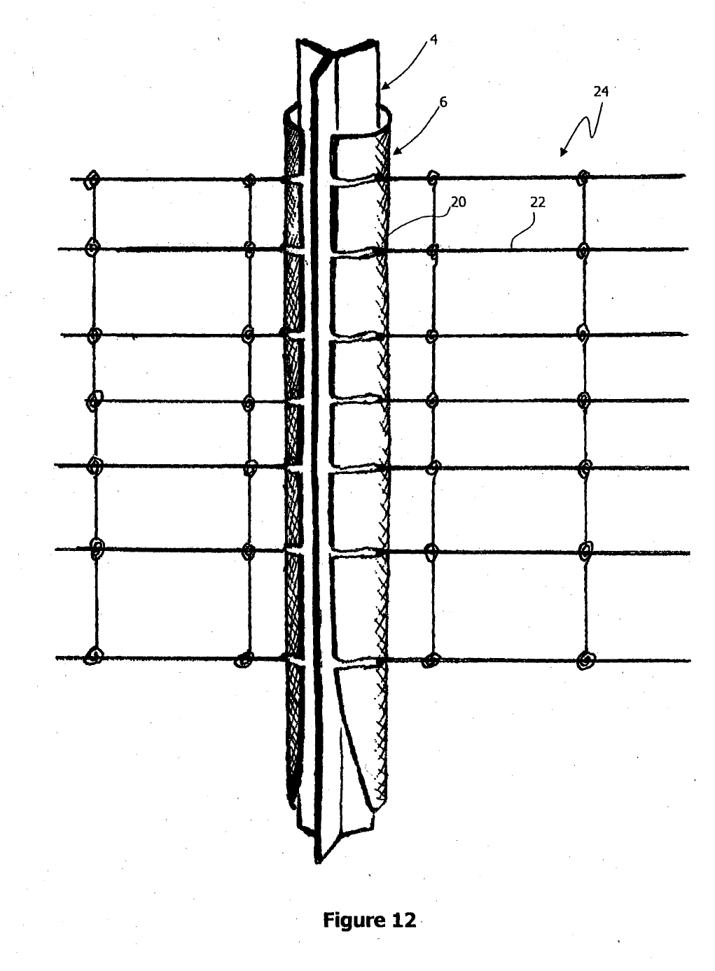

FIG. 12 shows fence mesh retained to the picket by the tube of FIG. 10;

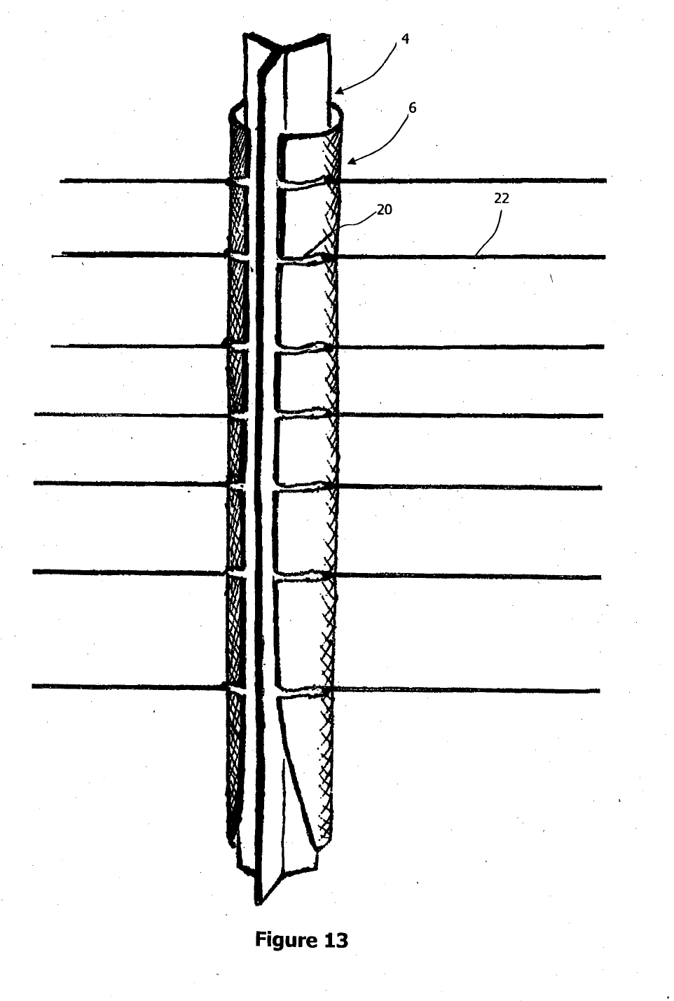

FIG. 13 shows a series of horizontal fencing wires retained to the picket by the tube of FIG. 10;

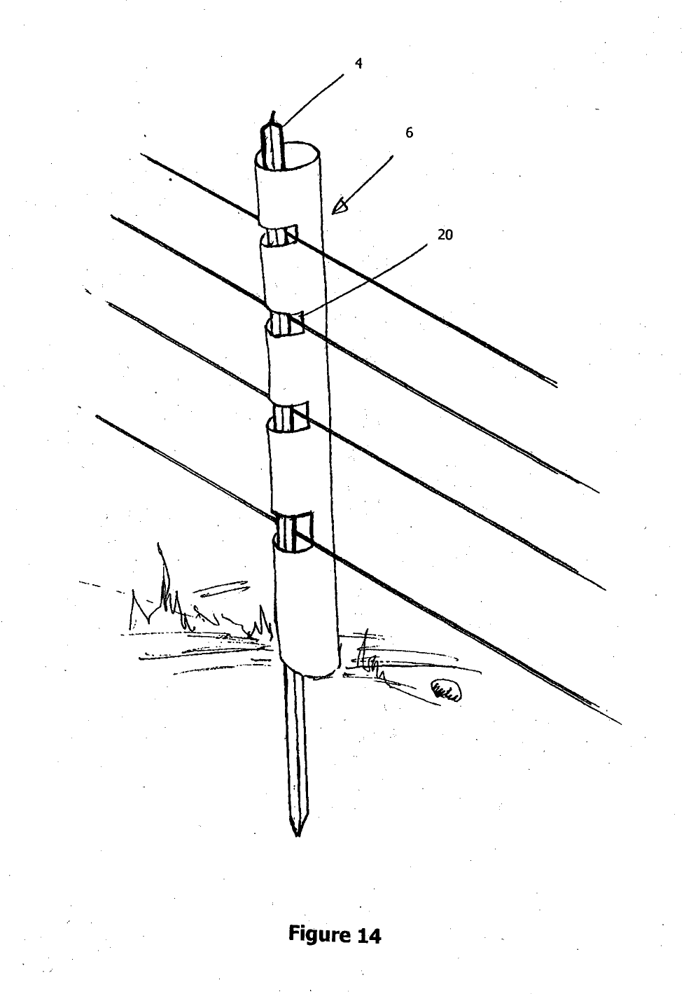

FIG. 14 shows a modified form of the retaining tube of FIGS. 10 to 13;

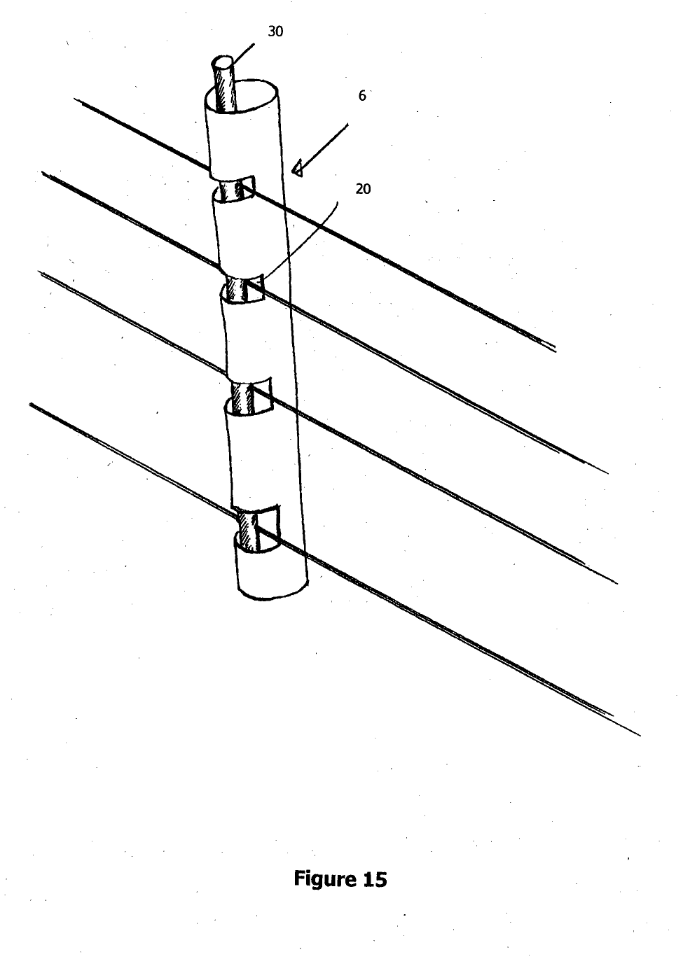

FIG. 15 shows a dropper formed by a retaining tube of the type shown in FIG. 14;

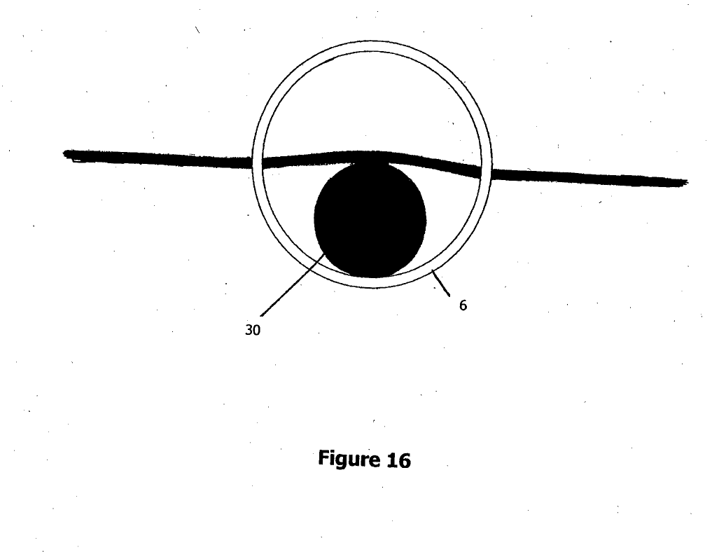

FIG. 16 is a schematic horizontal section equivalent to FIG. 15;

FIG. 17 shows a dropper formed by a rolled steel section;

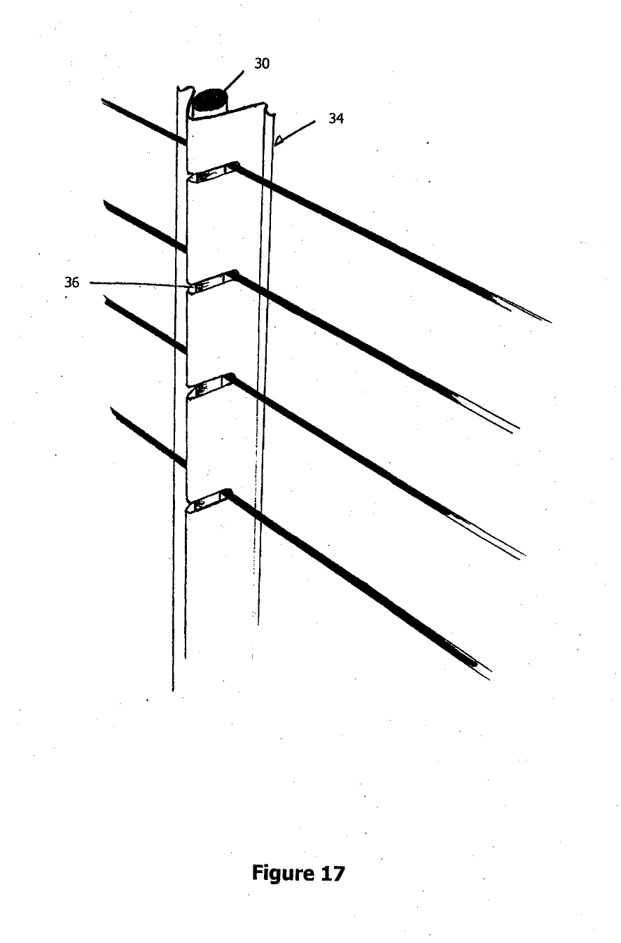

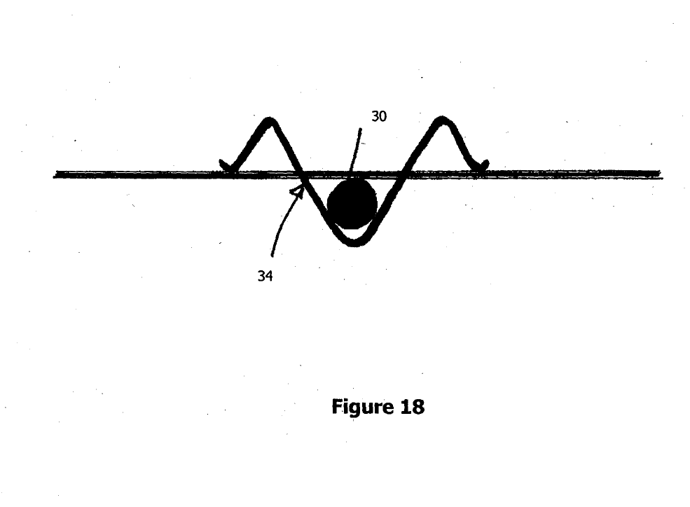

FIG. 18 is a schematic horizontal section equivalent to FIG. 17;

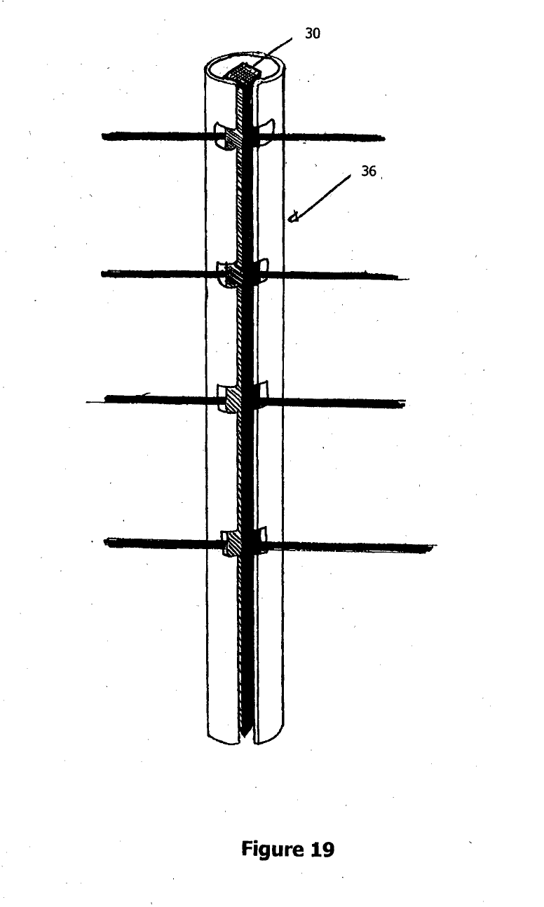

FIGS. 19 to 22 show droppers in the form of split plastic or metal tubes using locking rods of various cross-sections;

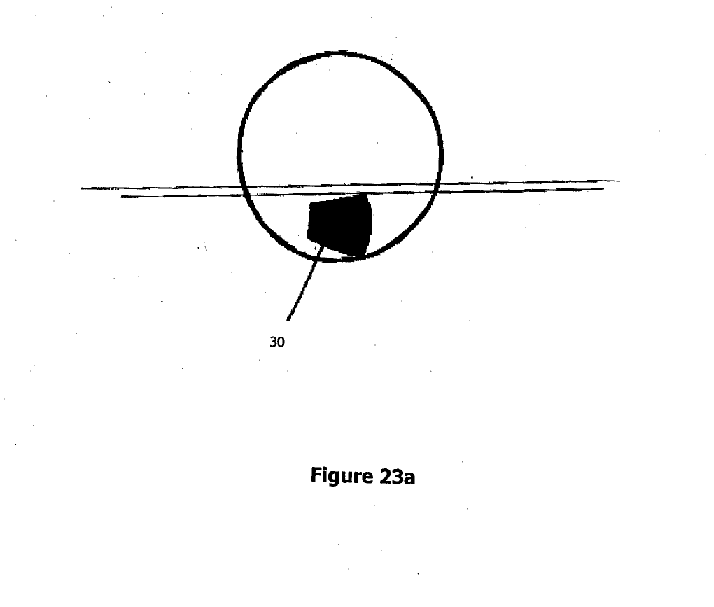

FIG. 23 shows a dropper similar to that of FIG. 15 but with a locking rod of yet another cross-section;

FIG. 23a is a view of the dropper of FIG. 23 but showing the locking rod inserted into the dropper prior to rotation into locking engagement with the wire;

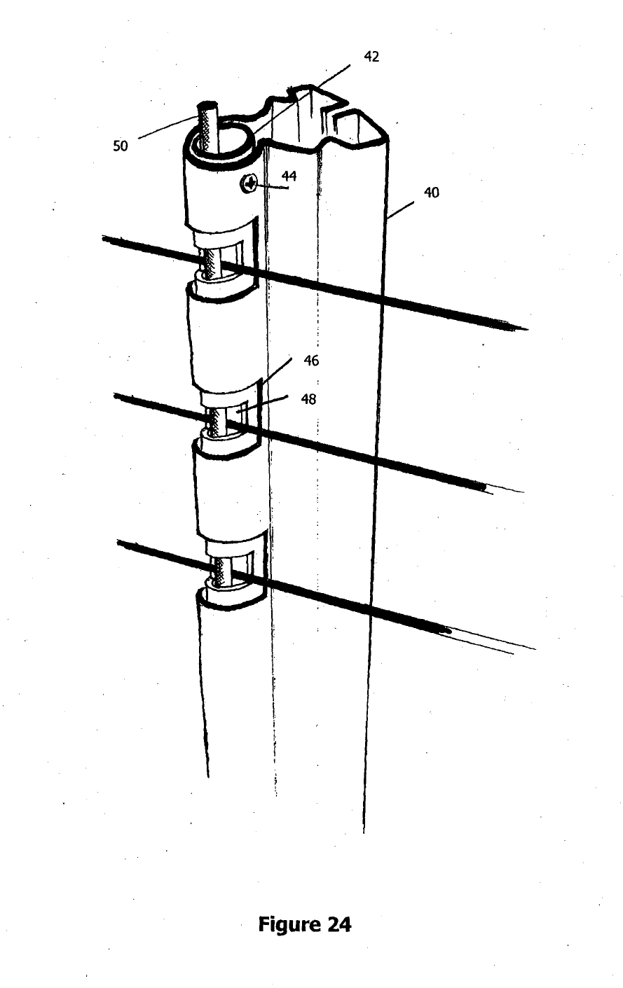

FIG. 24 shows an insulated post assembly for use with electric fence wires;

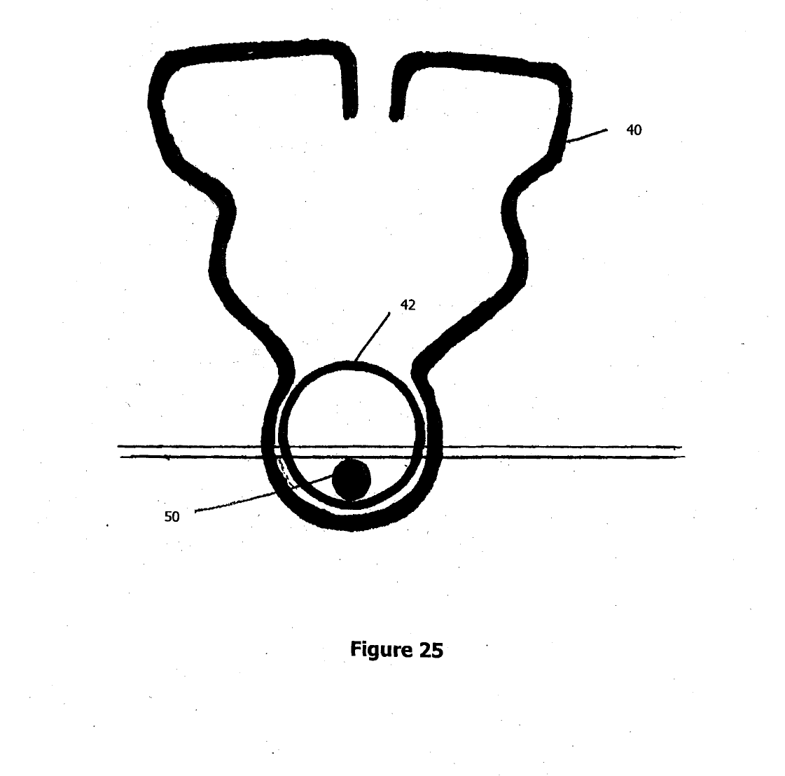

FIG. 25 is a schematic cross-section equivalent to FIG. 24;

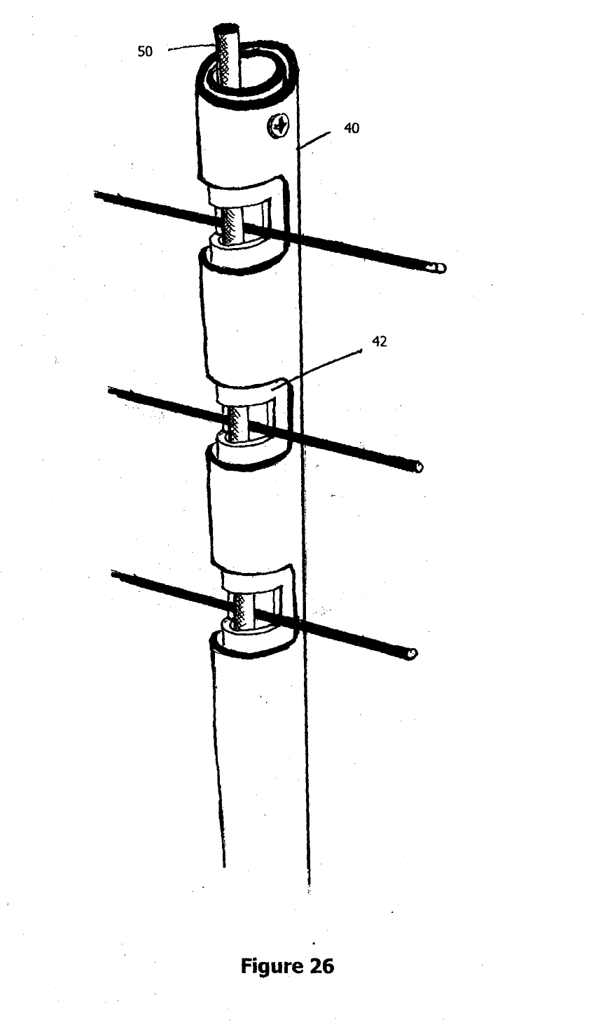

FIG. 26 shows an alternative form of the insulated post assembly;

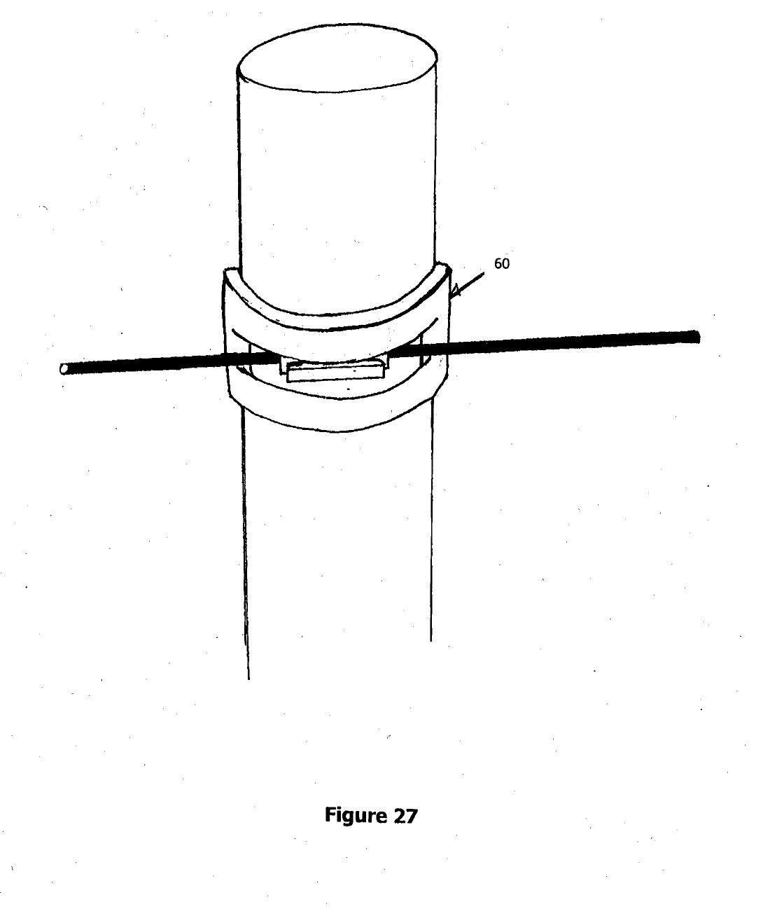

FIG. 27 shows a post with an insulating clip for retaining an electric fence wire;

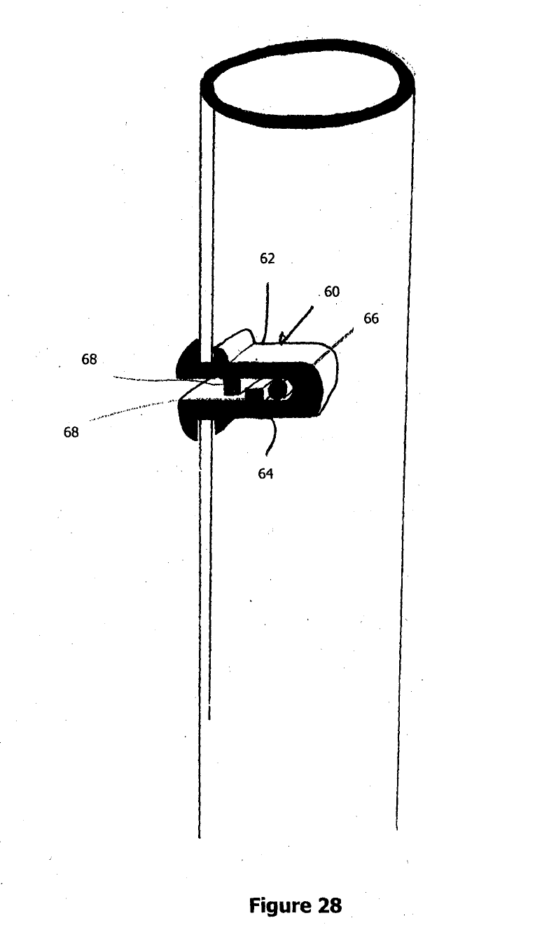

FIG. 28 shows the clip in cross-section as installed in the post;

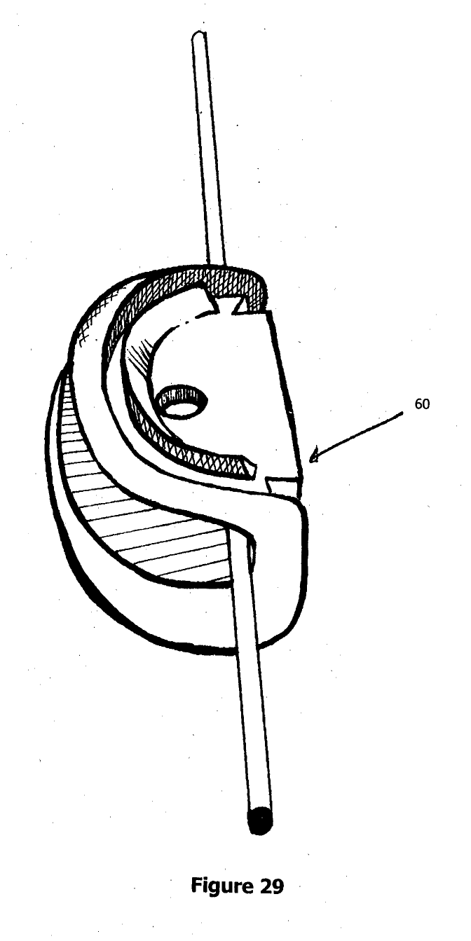

FIG. 29 is a perspective view of a clip having an alternative method of retaining the wire within the clip;

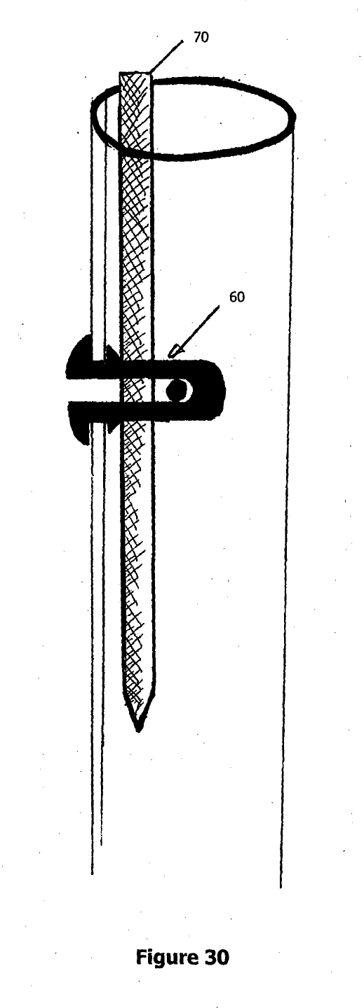

FIG. 30 shows the clip of FIG. 29 in cross-section as installed in the post;

FIGS. 31 and 32 show an alternative form of insulating clip;

FIG. 33 shows a steel corner post;

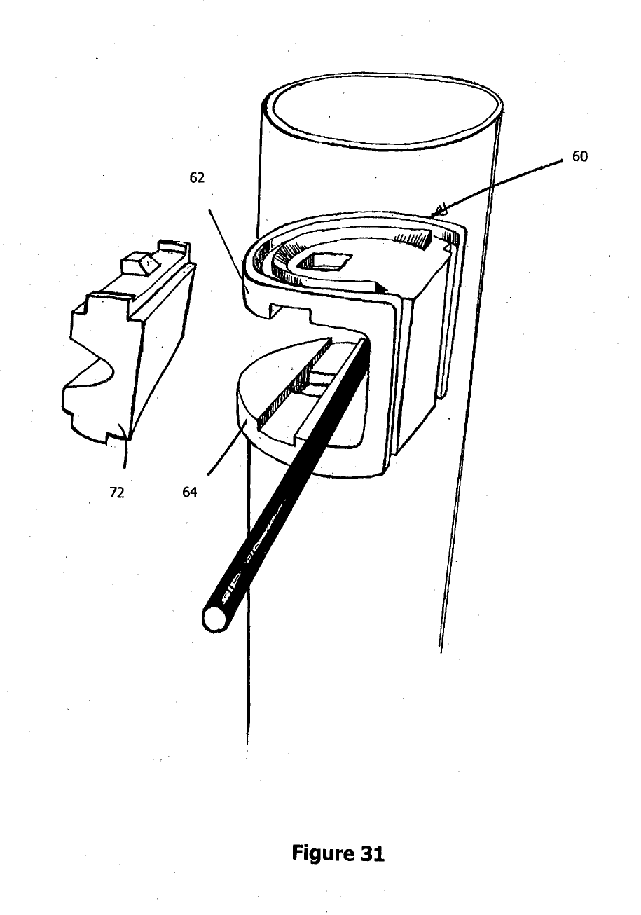

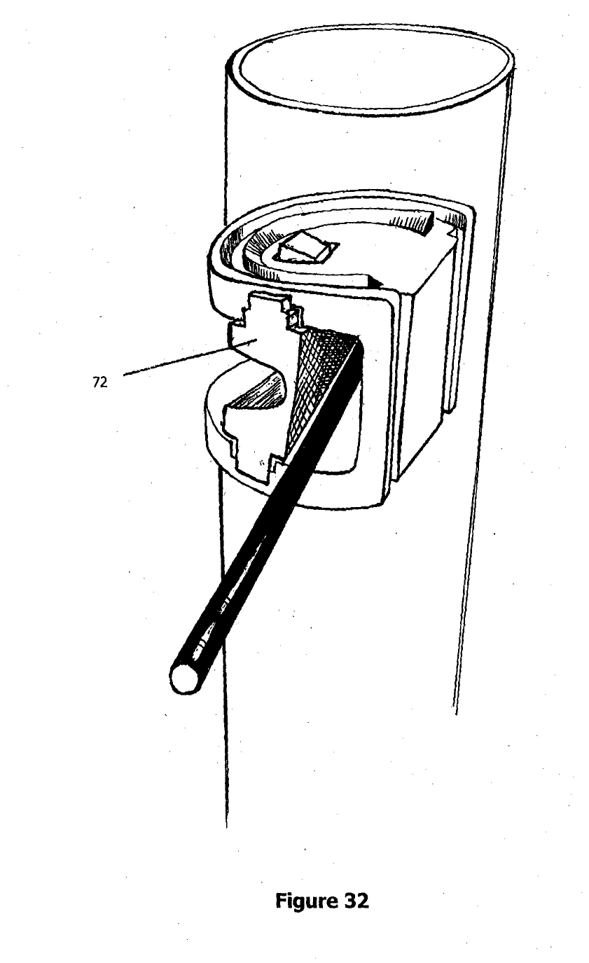

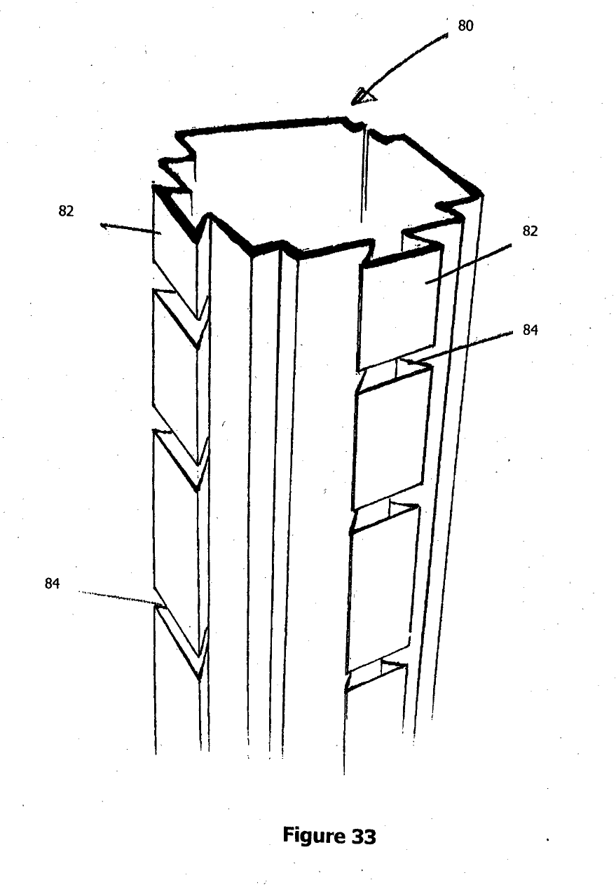

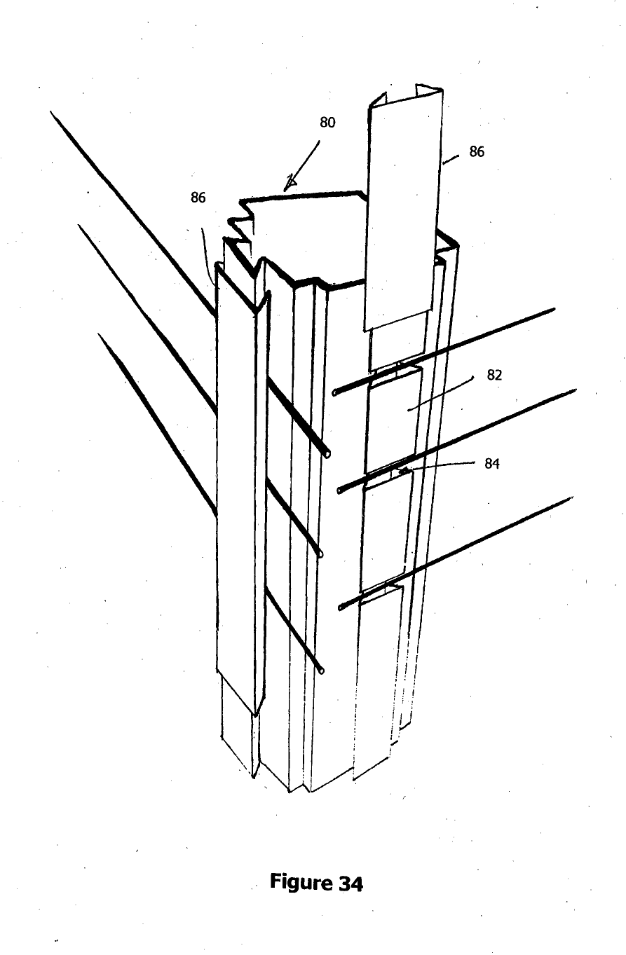

FIG. 34 shows how fence wires are retained to the corner post of FIG. 33;

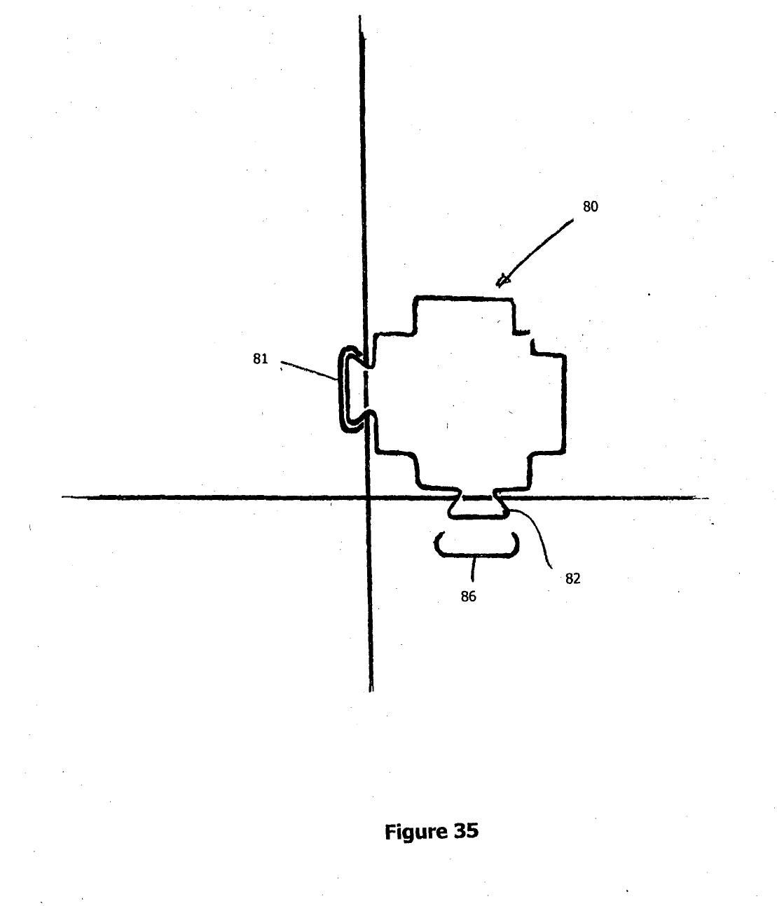

FIG. 35 is a schematic horizontal section equivalent to FIG. 34;

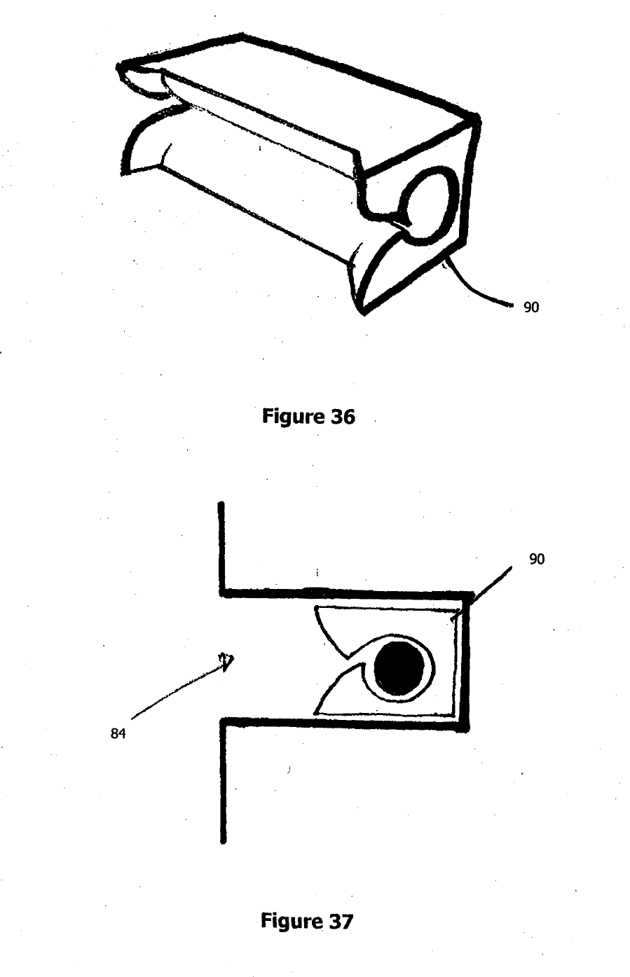

FIG. 36 shows an insulating clip for use in a post as shown in FIG. 33 for retaining an electric fence wire;

FIG. 37 shows schematically the location of the clip in a slot in the post of FIG. 33;

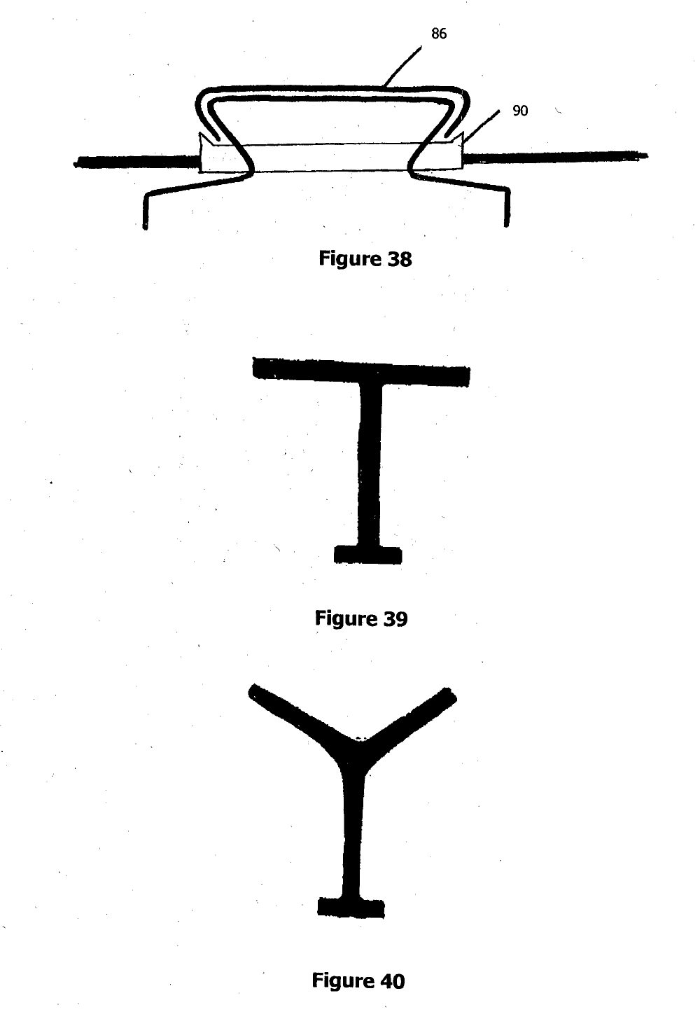

FIG. 38 is a schematic horizontal section equivalent to FIG. 37;

FIGS. 39 and 40 show alternative forms of steel picket in which one leg is flanged along its outer edge;

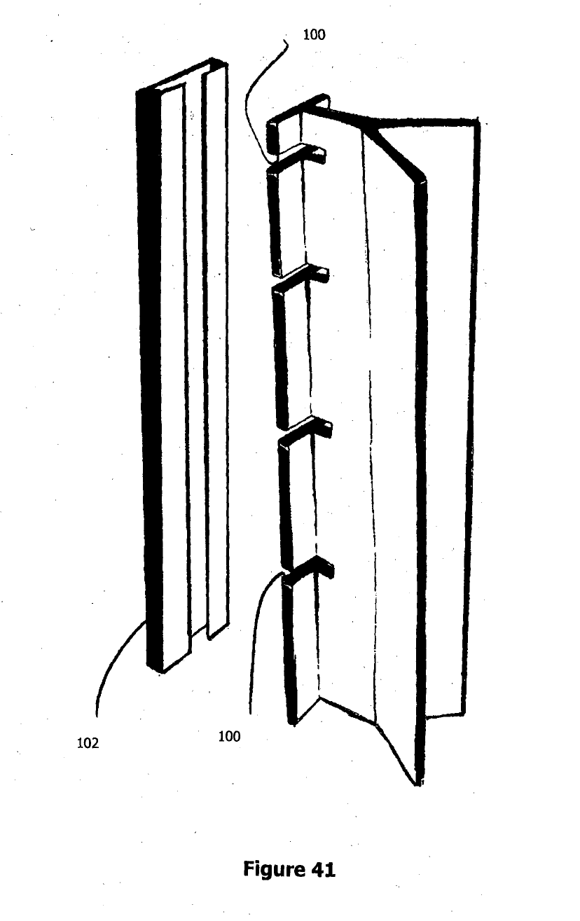

FIG. 41 shows how the pickets of FIGS. 39 and 40 can be used to retain fence wires in conjunction with a slide engageable over the flange;

FIG. 42 shows the slide attached to the picket and retaining fence wires;

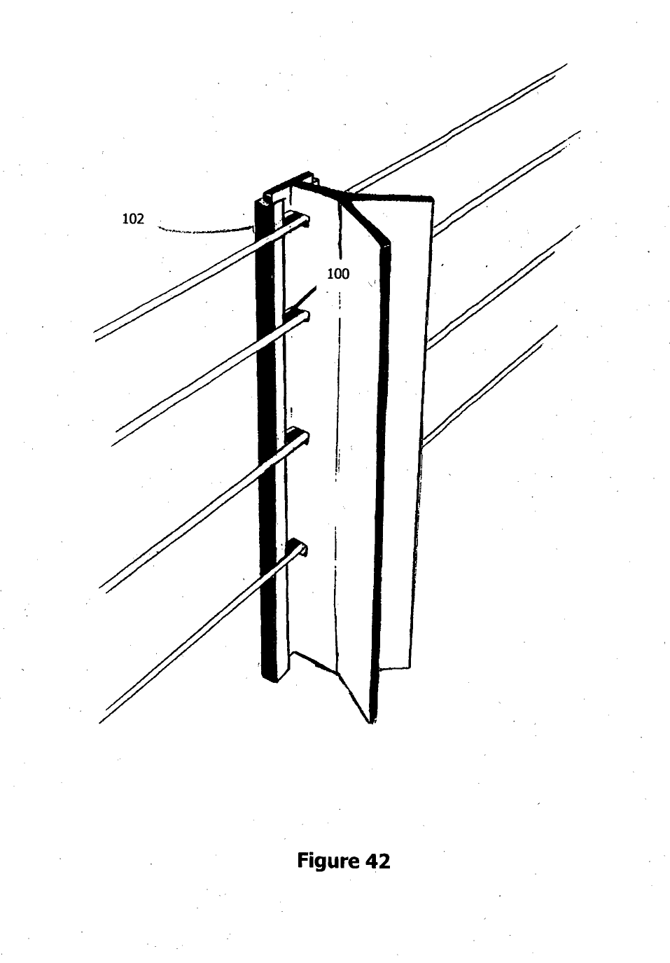

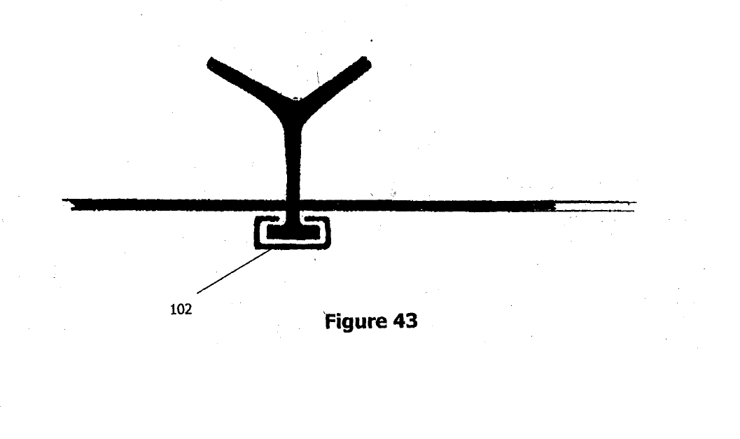

FIG. 43 is a schematic section equivalent to FIG. 42;

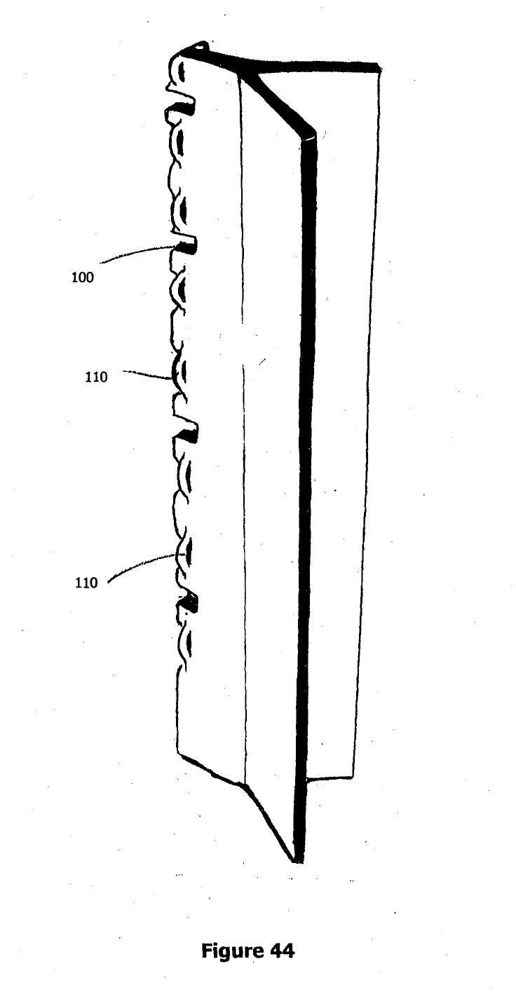

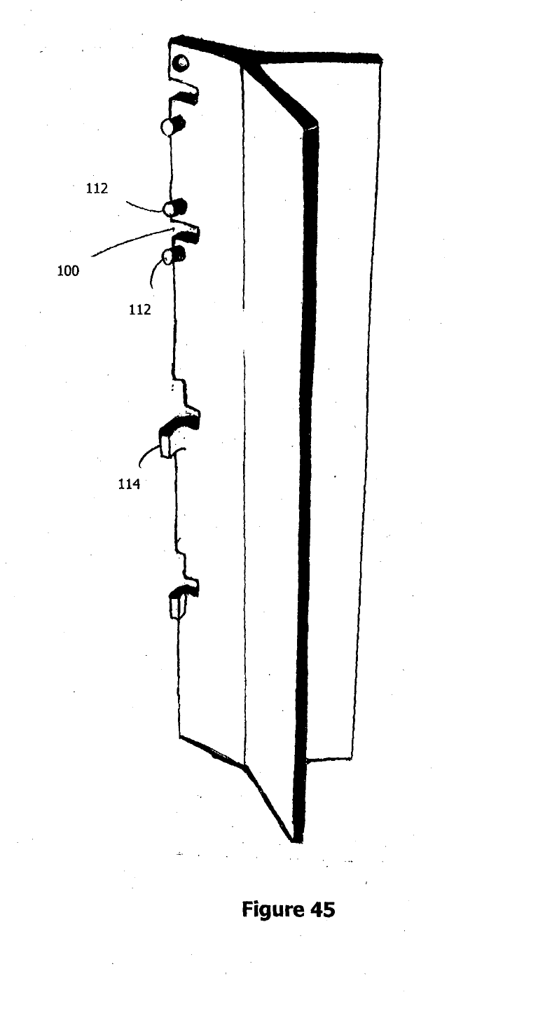

FIGS. 44 and 45 show pickets with other formations for engaging a wire-retaining slide;

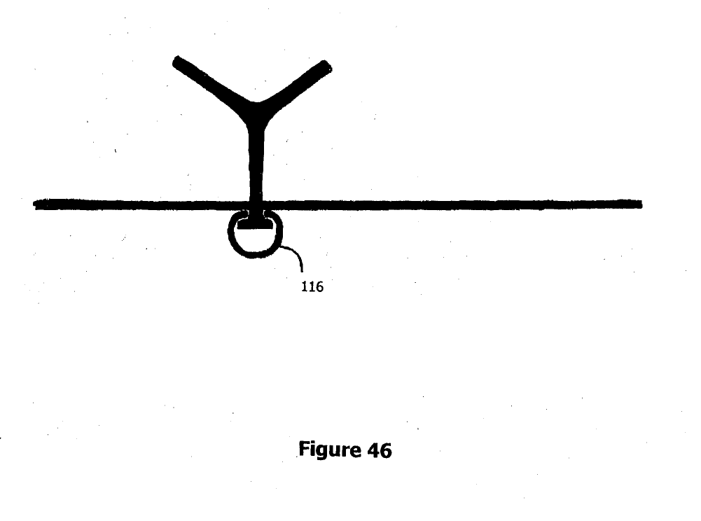

FIG. 46 shows the picket of FIG. 40 used in conjunction with a retaining tube similar to that of FIG. 2;

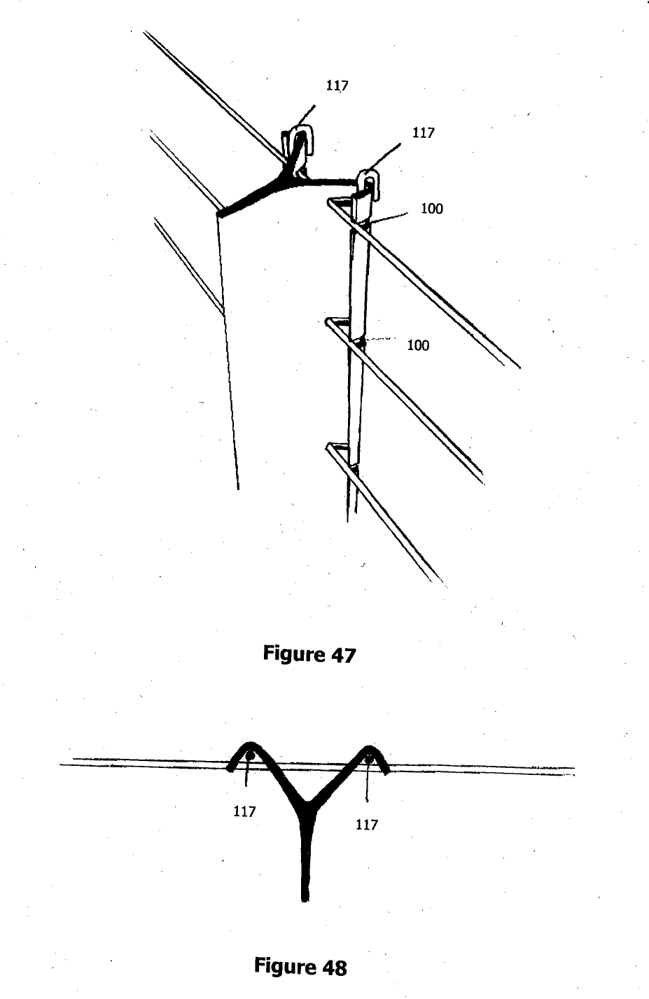

FIG. 47 shows a picket with another formation for retaining the wires;

FIG. 48 is a schematic horizontal section equivalent to FIG. 47;

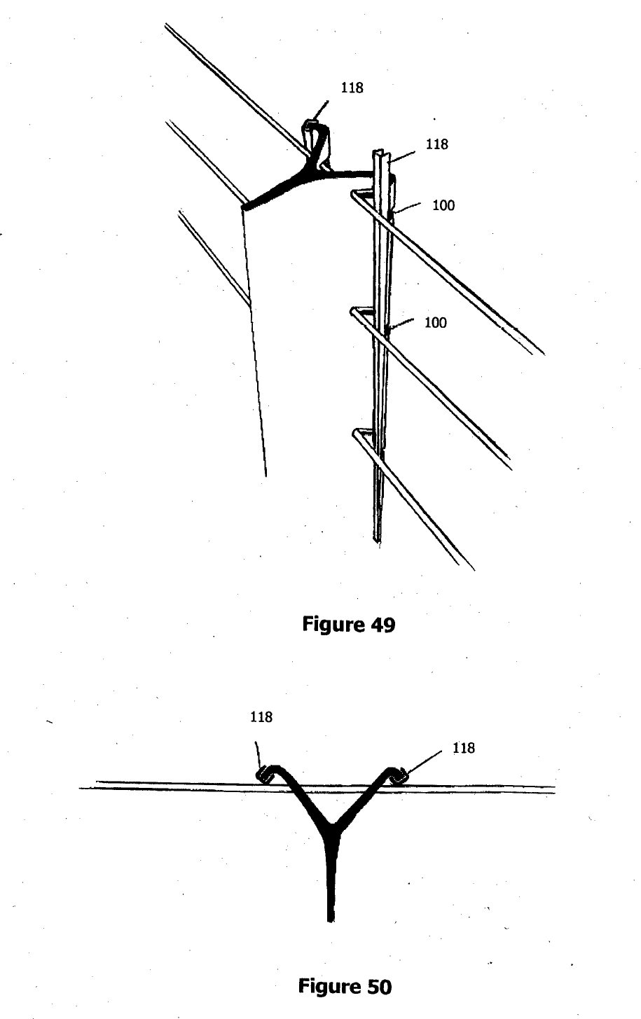

FIG. 49 shows a picket with yet another formation for retaining wires;

FIG. 50 is a schematic horizontal section equivalent to FIG. 49;

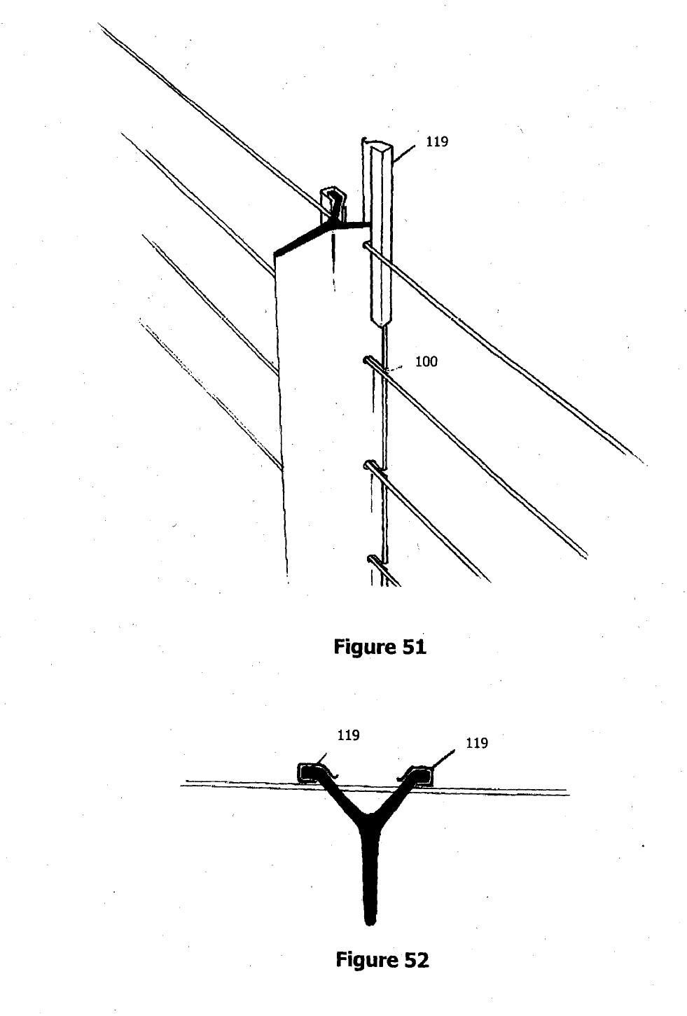

FIG. 51 shows a picket with yet another formation for retaining wires;

FIG. 52 is a schematic horizontal section equivalent to FIG. 51;

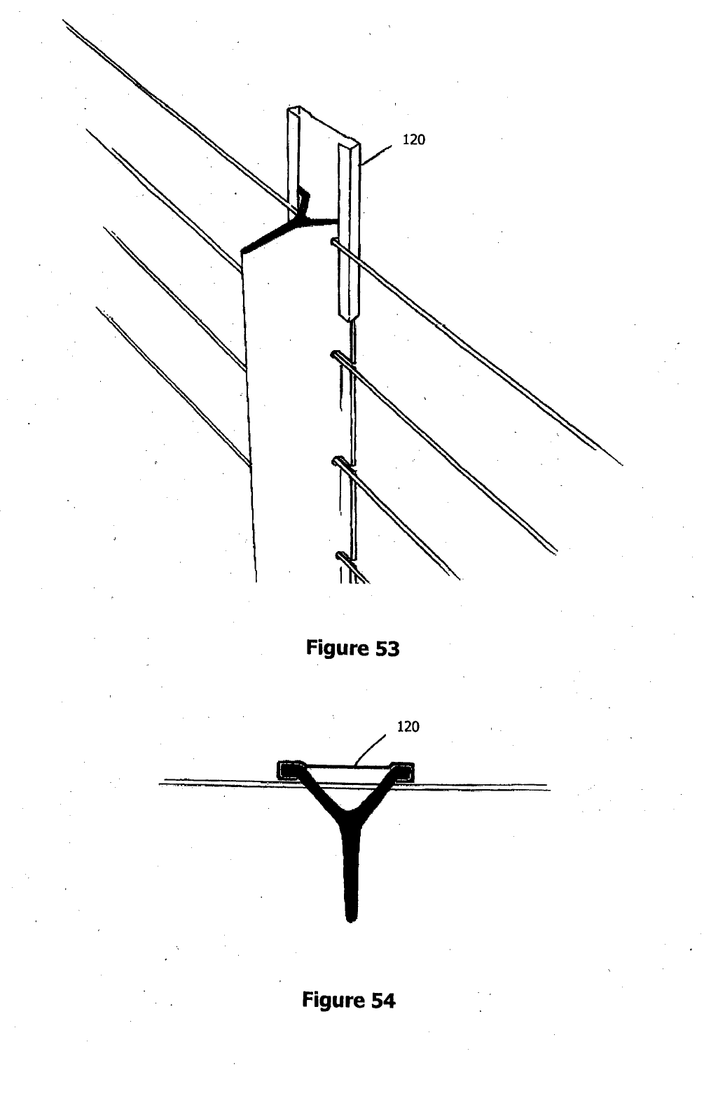

FIG. 53 shows a picket of the form shown in FIG. 51 but with an alternative form of wire retaining slide;

FIG. 54 is a schematic horizontal section equivalent to FIG. 53;

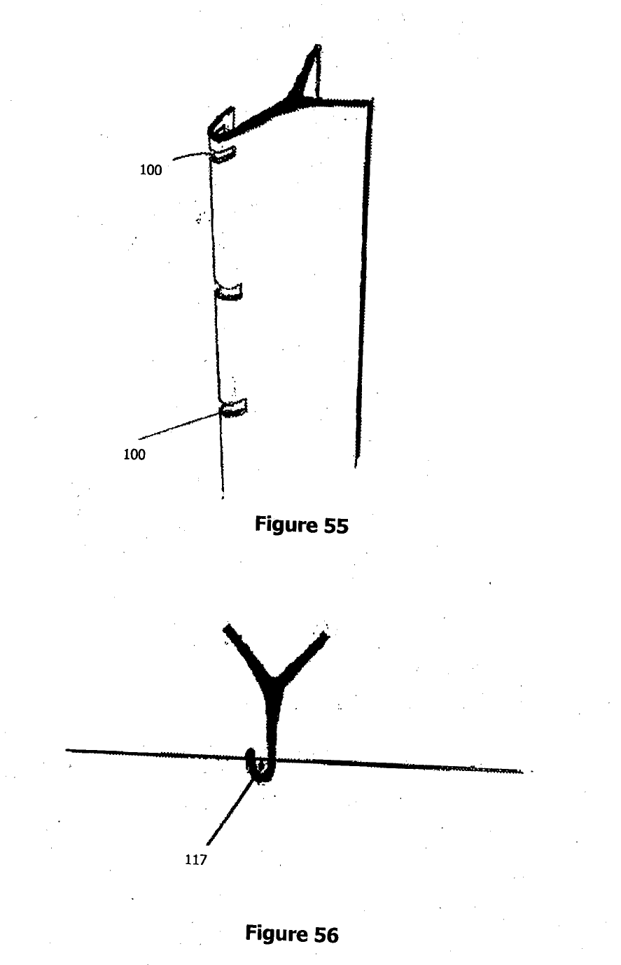

FIG. 55 shows a picket with yet another formation for retaining wires;

FIG. 56 is a schematic horizontal section equivalent to FIG. 55;

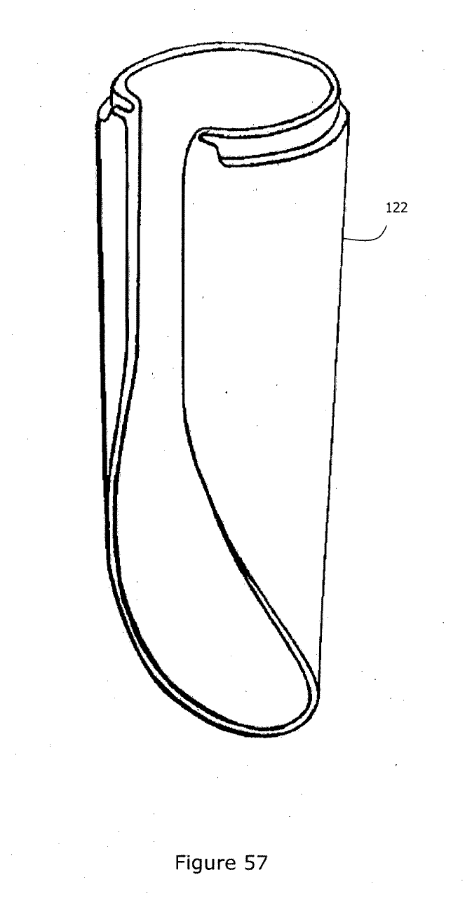

FIG. 57 shows an end fitting for a split tube of the type shown in FIGS. 1 to 13;

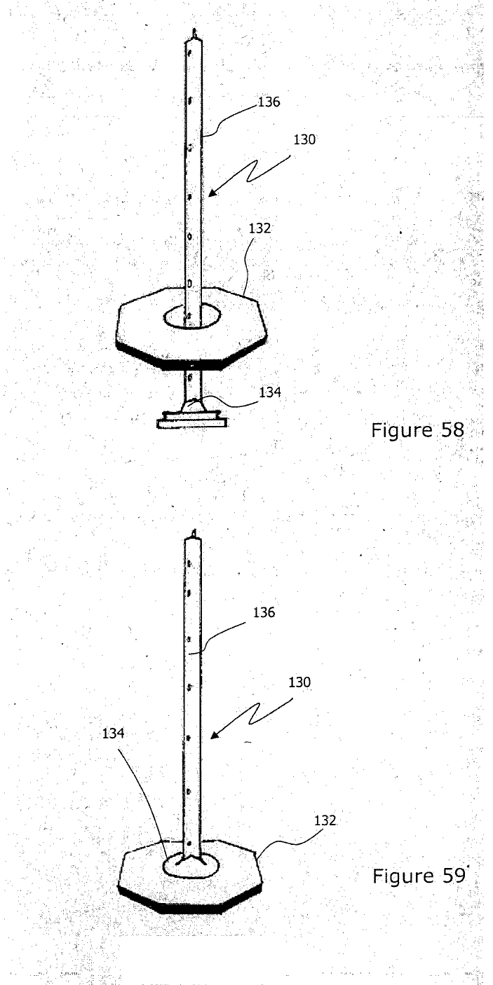

FIG. 58 is an exploded view showing a support or bollard for use on a paved or solid surface comprising a weighted base, and a picket mounted to an insert engageable in the base;

FIG. 59 shows the assembled bollard;

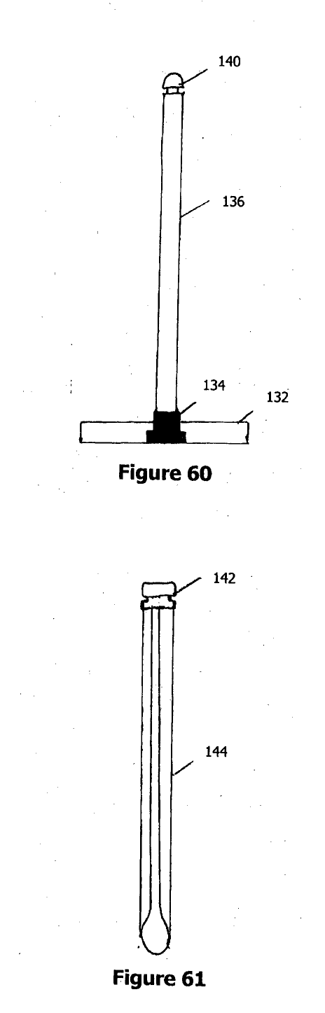

FIG. 60 shows a modified form of the bollard of FIGS. 58 and 59;

FIG. 61 shows a retaining tube for use with the bollard of FIG. 60; and

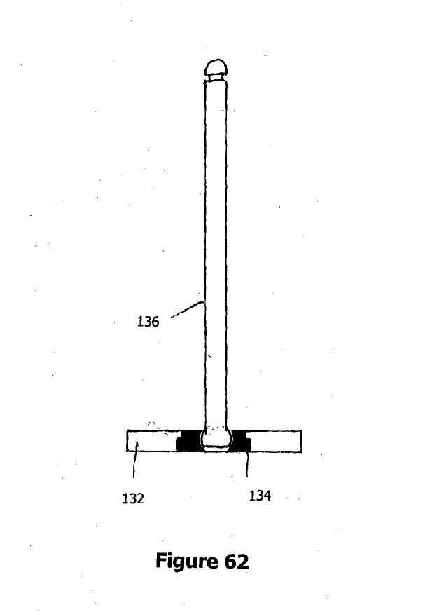

FIG. 62 shows a modified form of the bollard of FIG. 60 to provide a ball joint mounting.

The retaining system of the preferred embodiments of the invention comprises a substantially rigid tube, preferably of plastic, which acts in conjunction with a picket or stake driven into the ground to securely retain flexible fence/barrier material and the like without the need to tie the material to the picket or stake. By way of example, FIG. 1 shows the retention of plastic safety fence mesh 2 to a picket 4 of three legged cross section of the type sold under the registered trade mark “star picket”. The retaining system is principally formed by a substantially rigid retaining tube 6 which acts to retain the fence mesh 2 to the picket 4. With reference to FIG. 2, the tube 6 is slit to form a longitudinal slot 8 extending the entire length of the tube. At its lower end portion, the edges of the slot 8 are inclined outwardly as shown, to form a convergent entry mouth 10 leading into the remainder of the slot. The diameter of the tube 6 is such that when slid downwardly over the picket 4, one of the legs 4a of the picket can project outwardly through the slot 8 (see FIG. 3).

The plastic fence mesh 2 is installed by being placed against the edges of two of the three legs of the picket, the third leg of the picket being the leg 4a to project through the slot 8 in the tube 6. The tube 6 is then slid downwardly over the picket with its slot 8 aligned with the third leg 4a. As the enlarged mouth 10 at the lower end of the slot 8 moves over the fence mesh it draws the mesh around the picket and into the slot. This has the effect of wrapping the fence mesh around the picket, the mesh traversing a sharp angle as the mesh enters and exits the slot in its passage around the picket. This is schematically illustrated in the cross section of FIG. 4.

When the tube has been moved down over the full height of the fence mesh, the wrapping action just described creates a locking effect between the fence mesh and the picket along the entire height of the mesh whereby the mesh is firmly held against sagging. In the installation process, the fence mesh is held reasonably taught between the adjacent pickets whereby the tension of the plastic fence mesh is increased by the action of sliding the tube over the mesh as it wraps around the picket. Once the tube is installed, the mesh acting on the edges of the slot 8 in the tube will tend to pull the tube back against the other two arms of the picket thereby providing a further lock of the mesh against the picket.

The action described above can also be used to join two lengths of fence mesh without the use of any ties, the ends of the two lengths being overlapped in the zone of the picket whereby both will be firmly attached to the picket by application of the tube.

As mentioned previously, at its lower end portion the edges of the slot diverge outwardly to form the convergent mouth 10 which feeds the mesh into the slot when the tube is pushed down over the picket. It is particularly preferred for the divergent edges to be convexly curved from their upper to their lower ends as such a curvature enables the edge surface to slide more easily over the mesh without catching than would an edge that is substantially straight from its upper to its lower end. It is however to be noted that a straight divergent lower edge could perform satisfactorily when the flexible material to be retained by the picket is a non-mesh material such as woven plastic or fabric or plastic sheet material as may be used for windbreaks, warning signs, or advertising banners.

FIGS. 5 to 7 show a modification in which the slot 6 terminates slightly short of the upper end of the tube, and the tube is closed at its upper end by a cap 12. As a result, the upper end of the tube will project beyond the upper end of the picket and this, in conjunction with the cap 12, will act as a safety feature to prevent possible injury from the top of the picket. Also it will provide a more attractive appearance. FIG. 7 shows the attachment of a reflective tape 14 for safety purposes to the side of the tube opposite to the slot. In practice, it is envisaged that the picket with retention tube will be installed so that the slot 8 in the tube and the associated limb of the picket extending through the slot will be at the rear of the fence whereas the reflective tape 14 will be at the front of the fence to provide a possible warning to persons approaching the fence from that side.

Although as shown in FIGS. 5 to 7, the slot terminates short of the upper end of the tube, for ease of manufacture it may be preferred for the slot to continue to the upper end of the tube, with the tube being closed at its upper end by the protective cap 12 and the tube being of such a length that it extends above the upper end of the picket.

It is not essential for the retaining tube to be used in conjunction with a three-legged picket of the type just discussed although it is envisaged that the tube will mainly be used with that type of picket. FIG. 8 illustrates the use of the tube 6 with a square-sectioned stake 16, a wooden stake for example. The action of the tube 6 when applied to the stake 16 will tend to wrap the fence mesh tightly around the corners of the stake to thereby provide retention along its entire height in a broadly similar manner to that which arises with use of the three-legged picket.

As will be well understood from what has previously been said, the retention system of the invention is not confined to use with plastic fence mesh. FIG. 9 shows its use to retain flexible sheet material 18 which can function as a warning sign as specifically illustrated, an advertising banner, a screen, or a wind break. When the sheet material is of appropriate form it could act as a silt fence for use in erosion control.

As an additional safety feature, the tube can be fabricated from plastic including photo-luminescent additive or alternatively the post could be coated with photo-luminescent coating and which has the property of storing energy during daylight and emitting light at night thereby making posts and fence lines visible at night. This can be of significant advantage in public areas where lighting is poor or not available.

It is envisaged that the tube will be made in a range of different diameters to suit different shapes of, and sizes of picket or stake as may be available for day-to-day use.

FIGS. 10 to 13 show a modified version of the tube 6 for use with either wire mesh fence or wire fence. It differs from the tubes previously described in that the tube is formed with a series of vertically-spaced horizontal slots 20 extending part-way around the tube wall from the primary vertical slot 8. The horizontal slots 20 have a spacing equivalent to standard spacing of horizontal wire courses in standard wire mesh fences. This tube enables the wire mesh or fencing wire to be installed without being fixed to all of the pickets or posts which makes it easier and quicker to install and quickly dismantled. As an example of an installation procedure, pickets are installed along the line where a fence is to be erected, and wire mesh is rolled out next to the pickets. At each picket, the horizontal courses of the wire mesh are slotted into the horizontal slots 20 in the tube and the mesh with tube attached is lifted and dropped over the picket so that the portion of wire mesh extending within the tube is held captive between the picket and the wall of the tube as illustrated in FIG. 11 in which a horizontal course of the wire mesh is designated 22. FIG. 12 shows fence mesh 24 held captive to the picket 4 by the tube 6 without actually being attached to the picket and FIG. 13 shows similarly a series of horizontal fencing wires 22 similarly held captive to the picket 4. Similar considerations apply in the case of fence wires rather than fence wire mesh. Alternatively, with the wire mesh or fence wires engaged within the slots in the tube, the picket can be slid down the tube in front of the wires which locks the components together. The picket is then positioned and hammered into the ground. This is a quick and easy process, and the tapered end of the picket eases its passage past the wires. The same process can be used if the wire mesh or fence wires are pre-tensioned between end posts.

If the wire fence is to be electrified, this can easily be accommodated by installing a plastic insulating strip at the back of the picket when the tube with wire is moved over the picket. This is much quicker than attaching individual insulators for each wire to the picket as is currently the practice.

The tube of this variant could also be of the general form shown in FIGS. 5 to 7 with a cap at the end of the tube to minimise the risk of injury from contact arising with the picket.

Although in the tube of this embodiment the horizontal slots in the wall of the tube provide for its usage with wire fence mesh or fence wires as described above, the tube still has utility for the various applications described in connection with the first embodiment and therefore a practical embodiment of the invention may feature these additional slots to permit the same product to be sold for a wider range of possible uses.

The tubes, of FIGS. 2, 5 and 10 can also be applied to pickets of existing fences constructed with “star” pickets in which the fence wires are strung through a series of holes through a main leg of the picket. Even with the wires in place, the tube can be slid downwardly over the other two legs of picket. When thus applied, the tubes provide added visibility to the existing fence and also with a cap applied can provide protection for the upper edges of the picket. The tubes can also be coupled to the pickets of existing wire fences to retain flexible fence/barrier material/screen material or the like in the manner previously described with reference to FIGS. 1 to 7.

The tube of FIG. 10 with horizontal slots could also be used to attach extra wires to an existing wire fence, for example either to increase the number of wires in the fence, to add an electric wire to an un-electrified fence, or to add a wire mesh to the fence.

In a further modified form of the tubes of FIGS. 2 and 5, the tube is formed with a horizontal slot (equivalent to one of the slots 10 of FIGS. 10 to 13) at its upper end, and possibly a further horizontal slot at its lower end to retain upper or lower wires to act as support wires to which the flexible fence/barrier material/screen material can be tied in the span between the pickets to provide a stronger structure. In addition signs, lights or other items can be hung from the wire(s) between the pickets while still retaining the functionality of the flexible fence/barrier/screen.

A fence post consisting of a picket or stake driven into the ground in conjunction with a retaining tube of split form for use with wire fence mesh or fence wires as described, is also advantageous in that by designing the tube to be of an appropriate resilient strength, upon application of a high loading to the fence or fence wires, interaction between the tube and the picket or stake can cause the slot to widen and to disengage from the picket or stake under certain conditions and thereby to lower the barrier formed by the fence mesh or wires. This effect can be achieved by a selection of the thickness and/or material from which the tube is formed. This release effect is advantageous in situations where it might be necessary for the fence barrier to be removed in certain emergency situations. For example, if the fence is being used for crowd control, abnormal pressure applied to the fence in a stampede or crush could result in release of the retaining tube and thereby lowering of the fence in that area. Similarly a person(s) running out of a fenced area at night and not observing the presence of the fence could cause release when running into the fence at speed and thereby avoiding possible serious injury. A similar effect can occur in bush fire situations if animals are trying to escape from the fire by running against the fence. In all of these and similar situations, although the tube will be released to permit lowering of the fence and possible escape from the fenced area, the picket or stake will still remain in the ground and the integrity of the fence can quickly be re-established by re-coupling of the tube to the stake or picket.

FIG. 14 shows a modified form of the arrangement of FIGS. 10 to 13 in which the tube 6 is not slit lengthwise to provide the longitudinal slot and is thereby of a complete rather than slit cross section. This embodiment is principally designed for use with horizontal fencing wires and wire mesh. The tube is provided with a series of vertically spaced horizontal slots 20 for receiving the wires. In this configuration the entirety of the star picket lies within the tube and is driven through the tube and into the ground when the wires are in place within the slots to retain the wires within the slots in the manner shown in FIG. 14. By appropriately sizing the angular extent of the slots 20 in relation to the cross-sectional dimensions of the picket, the interaction between the picket and the wire can be used to frictionally lock the wire to the end edges of the slots and thereby to the tube if that is required. It is to be understood that the picket itself does not need to be a star picket and pickets of round, square or other section could alternatively be used.

A tube of the type shown in FIG. 14 can also be used as a dropper to maintain wire spacing between fence posts. This is shown in FIGS. 15 and 16 in which the tube 6 is locked to the wires by a clamping rod 30 of circular or other cross-section which is driven through the tube forwardly of the wires whereby the tube forces the wires against the end edges of the slots 20 whereby the clamping rod is frictionally locked within the tube 6 and the tube is frictionally locked to the wires to prevent displacement of the dropper along the wires. With this arrangement, if the tube is of plastic and if the clamping rod is of plastic or other non-conductive material, it will have particular utility for use with electric fence wires.

FIGS. 17 and 18 show a dropper 34 formed from a metal section, preferably a rolled steel section. A primary part of the section is substantially V-shaped and is formed with horizontally spaced slots 36 for receiving the fence wires. The dropper is locked to the wires by a clamping rod 30 driven into the interior of the section adjacent the apex of the V-shaped part to provide a clamping action equivalent to that described with reference to FIGS. 15 and 16. For use with electric fence wires, the wires can be fitted with insulating sleeves in the parts which traverse the dropper.

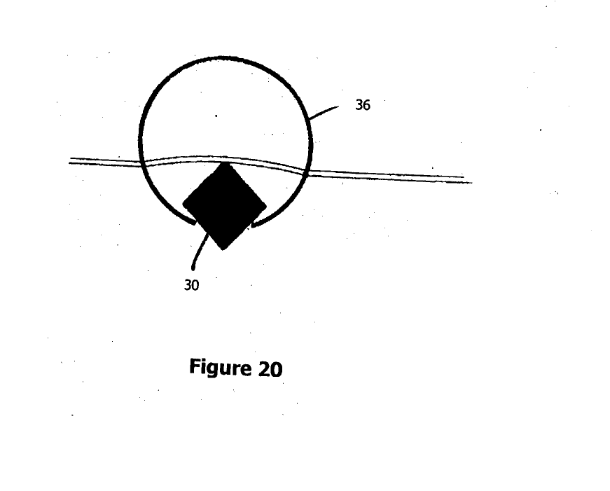

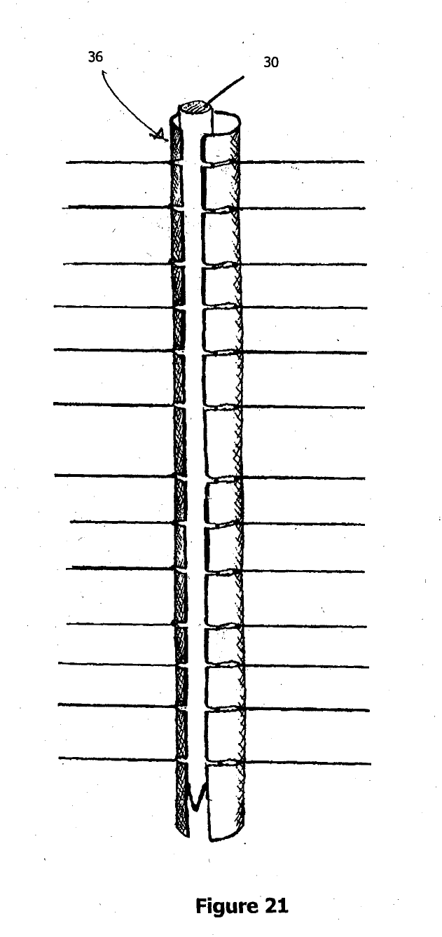

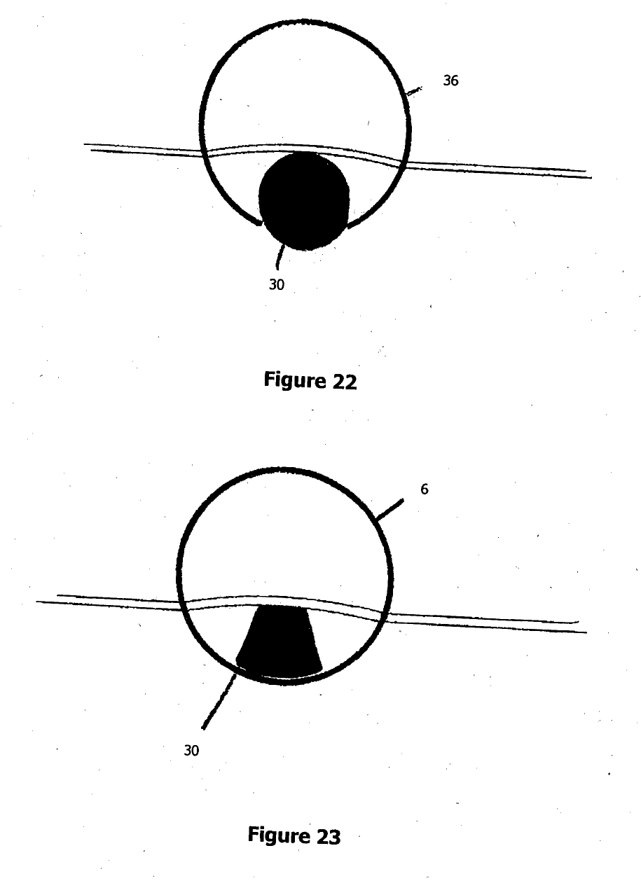

FIGS. 19 to 22 show droppers in the form of split plastic or metal tubes 36 which lock to the wire using the same principle as described in relation to FIGS. 15 and 16. FIGS. 19 and 20 show the use of a square-sectioned locking rod and FIGS. 21 and 22 show a round-sectioned locking rod, although it is to be understood that a rod of any suitable section could be used. FIG. 23 shows for example a locking rod of curvilinear section within the context of a dropper in the form of a closed tube as shown in FIGS. 15 and 16 but it could equally be used with the split tube version of FIGS. 19 to 22. With a locking rod of the section shown in FIG. 23, the rod can be slid easily into the tube in an angular orientation in which the wires are not lockingly engaged (see FIG. 23a), with locking engagement being achieved by then rotating by use of a suitable tool the locking rod into the angular orientation shown in FIG. 23 in which the curved side engages the inner surface of the tube, and the opposite side engages the wires.

FIGS. 24 and 25 show a post assembly having insulating characteristics for use with electrified fence wire. The post assembly consists of a main metal post 40, for example of rolled steel, carrying an insulating insert 42 in the form of a tube of plastic or other non-conductive material fitted within a curved portion of the profile of the post 40 and retained therein by screws 44 just one of which is shown in FIG. 24. The curved portion of the main post is formed with vertically-spaced slots 46 which form windows through which slots 48 formed in the non-conductive tube 42 are accessible. The conductive fence wires are retained in the slots 48 in the non-conductive tube by a plastic or other non-conductive locking rod 50 in the manner described in relation to the dropper of FIGS. 15 and 16. It is however to be understood that the height of the slots 48 in the non-conductive tube 42 and also their angular extent is such that the wires are maintained clear from electrical contact with the metal post itself. It is also to be noted that although in the case of a dropper it is necessary for the dropper to be fixed to the wires so that it cannot slide along the wires, in the case of a post which is driven into the ground while the post provides both vertical and horizontal anchorage of the wires it is not strictly necessary for the wires to be frictionally clamped to the post as the post itself cannot move although it is possible for a frictional clamping effect to exist.

FIG. 26 shows an insulated post assembly of similar form but with the main metal post 40 in the form of a closed tube of circular form. It is however to be understood that tubes of other cross section could alternatively be used.

FIGS. 27 and 28 show an alternative approach to mounting electrical fence wires to a metal post. As shown in these figures, this involves a clip 60 of plastic or other non-conductive material engaged in a slot in the wall of the post to retain the wire. Although only one such clip mounted to the post is shown in these figures, it will of course be understood that the post will be provided with a series of slots vertically spaced with a clip for a corresponding fence wire being located in each slot. In the form shown in these figures, the clip 60 comprises two wings 62, 64 integrally connected by a hinge 66 at their inner ends. With the two wings hinged to an open condition the clip can be installed to the wire with the wire lying inside the clip towards the hinge end thereof and when the two wings are hinged to their closed condition the wire is trapped within the clip by an internal abutment 68 on one or both wings (both wings as shown). The material of the clip has a degree of resilience whereby when in its closed condition it can be pushed into the slot in the post and locks into the slot with a snap fit with the upper and lower edges of the slot being engaged within grooves at the upper, and lower surfaces of the clip. In a modification as shown in FIGS. 29 and 30, the internal abutment(s) within the clip is omitted which allows the clips to be pre-fitted to the post, with the wire then being installed into the clip and then retained within the clip by a locking rod 70 of plastic or other non-conductive material moved downwardly through vertical apertures in each clip outwardly of the wire. The locking rod 70 could be supported at its lower end simply by resting on the ground or alternatively it could be supported from its upper end by hooking over the top of the post or by some other form of attachment to the upper end of the post.

FIGS. 31 and 32 show an alternative form of insulated clip for pre-mounting in the post. The wire, after installation within the clip, is retained within the clip by installation of a separate lock member 72 snap-mounted into the open mouth of the clip as shown in FIG. 32. It is to be noted that this form of clip could alternatively be used with a locking rod 70 of FIG. 30 due to the presence of the upper and lower apertures in its two wings designed to interfit with locking abutments on the lock member. The use of the locking rod as an alternative to the lock member 72 may be of advantage in some practical situations where it may be required quickly to remove the fencing wire from time to time.

FIGS. 33 to 35 show a steel corner post 80 in which one pair of adjacent sides is formed with projections 82 extending longitudinally and of undercut shape, as shown dovetail shape but other shaping could be used. Each of these is formed with vertically-spaced slots 84 for receiving the fence wires as shown in FIGS. 34 and 35. When inserted into the slots 84, the wires are retained to each post by a slide 86 of corresponding cross section slid downwardly to retain the wires against withdrawal. Alternatively the wires could be retained to the post by a rod of appropriate cross-section, circular or U-shaped for example, inserted downwardly through the projection 82 to retain the wires in a manner similar to that of FIG. 14. Although the post shown is a corner post for retaining two sets of fence wires at right angles, the post could alternatively be formed as a single projection 82 for retaining just a single set of fence wires.

To adapt the arrangement of FIGS. 33 to 35, for use with electric wires, the wires are engaged within inserts 90 of plastic or other non-conductive material mounted within the slots and retained by the slides as shown in FIGS. 36 to 38.

The general principles of the retention system described with reference to FIGS. 33 to 35 are also applicable to a rolled steel post having outwardly directed legs, with at least one of the legs having a lateral flange at its outer edge. Examples are shown in FIGS. 39 and 40 although the concept is applicable to other cross sectional configurations. It would be appreciated that the section of FIG. 40 is equivalent to a “star picket” with just one of the legs flanged at its outer edge. As shown in FIG. 41 in relation to the post of FIG. 40, the flanged leg is provided with a series of vertically spaced slots 100 at its outer edge portion. Fence wires are engaged in the slots and are retained in the base of the slots by a slide 102 slid downwardly over the flanged end as shown in FIGS. 42 and 43.

In a modification instead of an outer flange to retain the slide 102, the outer edge portion of the leg can be formed on each side with formations to retain the locking slide. FIG. 44 shows raised formations 110 for this purpose and FIG. 45 shows schematically pegs 112 or tangs 114 projecting laterally from each edge of the leg; it should be understood that in this case, the post will have either pegs or tangs, but not both.

FIG. 46 shows a star picket as shown in FIG. 40 but used in conjunction with a split tube 116 corresponding to that of FIG. 2 to retain the wires in the base of the slots. It is believed that the tube 116 will be somewhat easier to apply than the slide 102 of FIGS. 41 to 43 due to reduced friction.

FIGS. 47 and 48 show a star picket in which the ends of two of its legs are bent outwardly in the manner shown, with slots being cut through the bent outer portions and adjacent parts of the arms of the picket to receive the fence wires which are retained within the slots by locking rods 117 in a manner corresponding to that previously described. This embodiment shows the locking rods 117 with hooked end portions which hook over the upper ends of the two legs of the picket to retain the rods to the picket.

In an alternative, the separate locking rods 117 are combined to form a U-shaped locking pin, the base of which spans the upper edges of the two legs of the picket, and the legs of the pin extend downwardly in a similar manner to that of the locking rods. In this configuration the divergence of the two picket legs will act to resist lateral outwards movement of the locking pin whereby the wires will be retained towards the rear of the slots.

A picket of the profile shown in FIGS. 47 and 48 is easy to manufacture as the bent end portions of the two arms can be configured within a rolling process by which the picket is shaped. The attachment of the wires to two legs of the picket adds stability to the picket.

A picket of the form shown in FIGS. 47 and 48 in conjunction with the locking rods 117 provides an inexpensive and effective way of retaining the fencing wires.

In the configuration of FIGS. 47 and 48 the bent end portions of the two legs extend across the wire to ensure that the locking rods 117 are properly retained and cannot dislodge. In an alternative configuration shown in FIGS. 49 and 50 the end portions are somewhat shorter and are designed to receive locking sleeves 118 which fit over the end portions to which they are retained by engagement with the wires as shown and it would be understood that in this configuration the sleeves act to retain the wires in the base of the slots 100 in the two legs.

FIGS. 51 and 52 show a further alternative in which the ends of the two legs extend laterally outwardly in substantial alignment and are adapted to receive a wire-locking slide 119 having a profile corresponding to that of the end portion of the leg so that when applied to the leg it cannot be accidentally removed. The slide can be applied either by sliding it downwardly along the leg or by applying it to the outer edge of the leg and then forcing it sideways over the leg by hitting with a mallet, the slide having sufficient resilience to lock over the end of the leg in this configuration.

FIGS. 53 and 54 show a picket of the form of FIGS. 51 and 52 but with a single wire retaining slide 120 engaged over the outer ends of the two legs.

In the picket of FIG. 55, the main leg of the picket is bent over at its outer edge and formed with slots 100 at its outer edge. The slots terminate short of the end edge of the bent over portion which enables the wire to be retained in the slots by a locking rod 117 located in the void formed by the bent over portion and which can be hooked over the upper end of the arm as shown for example in FIG. 47.

The picket profiles of FIGS. 49 to 56 are, like that of FIGS. 47 and 48, easy to make using standard rolling techniques. All can be insulated for use with electric fencing using the various methods described earlier.

For the avoidance of doubt, it is to be understood that in the many embodiments which include slots for receiving horizontal fence wires, the fence itself may be constituted just by horizontal wires or by wire fence mesh in which case the slots receive the horizontal wires of the mesh.

Reverting back to the embodiments of FIGS. 1 to 13, the convergent mouth 10 at the lower end of the slot 8 rather than being formed as an integral part of the overall tube could be formed by a separate fitting which is fitted at the lower end of the slotted tube. Such a fitting 122 is shown in FIG. 57 and this may be attached to the bottom of the slotted tube.

FIGS. 58 and 59 show a bollard 130 for use on a paved or other solid surface and consisting of a weighted base 132 with a central aperture into which locks a plastic or rubber insert 134 for receiving a stake or picket 136 preferably of moulded plastic. The picket or stake is of a size comparable to that of existing “star” pickets and the like, whereby the bollard can be used in conjunction with the tube for retaining flexible fence/barrier material/screen material as already described with reference to FIGS. 1 to 13. It is to be noted that weighted bases 132 of the type in question are currently available for supporting plastic bollards but existing plastic bollards are of a size which would render them impractical for the various uses described herein. The moulded insert 134 which fits into the aperture in the base provides an inexpensive conversion for its usage as just described. The insert 134 can be formed as a ball joint to enable the picket or stake to extend upright, when the base is resting on sloping ground.

FIG. 60 shows a bollard as described above in which the picket 136 of moulded plastic of tubular form has at its upper end a locking formation 140 engageable with a locking formation 142 at the upper end of retaining tube 144 (FIG. 61) corresponding to that previously described. The tube 144 is locked to the picket 136 by engagement of the formations 140, 142 which are designed to permit release by a counter-intuitive action involving manipulation of the tube to reduce the possibility of its removal by vandals.

FIG. 62 shows the bollard of FIG. 59 in conjunction with an insert 134 both configured to provide a ball jointed connection as discussed above.

The embodiments described are given by way of example only and modifications are possible within the scope of the invention.

1. A retention system comprising a tube adapted to be fitted over a picket or stake for retaining relative to the picket or stake flexible fence, barrier, screen material or the like, the wall of the tube including a slot extending longitudinally of the tube over at least part of its length, the slot being open at its lower end and being shaped at its lower end to provide a convergent mouth which leads into the slot to facilitate entry into the slot of flexible material against a side of the picket or stake remote from the slot when the tube is moved downwardly over the picket or stake whereby the tube acts to anchor the flexible material against the picket or stake.

2. A retention system according to claim 1, wherein the tube has a protective cap at its upper end.

3. A retention system according to claim 1 or claim 2, wherein the tube has a series of transverse slots opening onto the longitudinal slot at each edge thereof, the transverse slots being longitudinally-spaced whereby when the tube is applied to a picket or stake the transverse slots extend horizontally to receive horizontal wire runs of fencing wire or wire fence mesh.

4. A retention system comprising a tube for use in conjunction with a picket or stake for retaining horizontal wire runs of fencing wire or of wire fence mesh, the tube having a slot extending longitudinally along at least part of its length, the slot opening to the lower end of the tube, the tube having a series of transverse slots opening onto the longitudinal slot at each edge thereof, the transverse slots being longitudinally-spaced whereby when the tube is applied to a picket or stake the transverse slots extend horizontally to receive the horizontal wire runs which enter the interior of the tube and are retained within the tube by the presence of the picket or stake.

5. A post for a fence consisting of horizontal runs of fencing wire or of wire fence mesh, the post having along its length vertically-spaced horizontal slots each serving to receive a fencing wire by lateral movement of the wire into the slot, and means for retaining the wires within the slots.

6. A post according to claim 5, wherein the means for retaining the wires within the slots comprises a stake or picket driven downwardly through the post to capture the wires within the slots of the post.

7. A post according to claim 5, wherein the means for retaining the wires in the slots comprises a rod moved downwardly through the post to capture the wires within the post.

8. A post according to any one of claims 5 to 7, wherein the post is suitable for electric fence wires, the post is of metal, and clips of an electrically insulating material are engageable in the slots whereby the clips act to electrically insulate the wires from the post.

9. A post according to claim 8, wherein the clips resiliently lock into the slots and the structure of the clips when locked into the slots act to retain the wires.

10. A post according to claim 8, wherein the clips resiliently lock into the slots and the wires are retained in the clips by a rod of an electrically insulating material inserted downwardly through a group of clips within the post.

11. A post according to claim 5 for electric fence wires, wherein the post is of metal, a tube of an electrically insulated material is within the interior of the post and has slots which open onto the slots of the post whereby the fence wires pass through the slots in the post by passage through the slots in the tube, and means for retaining the wires within the slots in the tube to thereby be maintained out of electrical contact with the metal post.

12. A dropper for mounting on horizontal wire runs of fencing wire between fence posts to maintain the runs in spaced relation, the dropper comprising a member having along its length vertically-spaced horizontal slots each serving to receive a fencing wire by lateral movement of the wire into the slot, and means for retaining the wires within the slots and for anchoring the member to the wire to prevent movement of the member along the wire.

13. A dropper according to claim 12, wherein the member is a tube, and the means for retaining the wires within the slots comprises a rod moved downwardly through the tube to capture the wires within the slots.

14. A dropper according to claim 13, wherein the tube and the rod are of an electrically insulating material.

15. A dropper according to claim 12, wherein the member is a metal section, and the means for retaining the wires within the slots comprises a rod moved downwardly through the section to capture the wires within the slots.

16. A post for retaining horizontal wire runs of fencing wire or of wire fence mesh, the post having a longitudinally-extending formation with longitudinally-spaced slots for receiving the wires by lateral insertion of the wires into the slots, and means engageable over the formation after engagement of the wires within the slots to retain wires within the slots.

17. A post according to claim 16, wherein the retaining means is engaged over the formation and is retained thereto by complimentary cross-sections of the formation and retaining means.

18. A post according to claim 16 or claim 17, wherein the engagement between the retaining means and the formation is a sliding engagement with the retaining means being slid downwardly along the formation after engagement of the wires in the slots of the post.

19. A post for retaining horizontal wire runs of fencing wire or of wire fence mesh, the post being in the form of a stake or picket having a cross-sectional configuration formed by a plurality of legs, wherein at least one of the legs is formed with vertically-spaced generally horizontal slots opening to an outer edge of the leg for receiving the horizontal wire runs, and means engageable over the outer edge of the leg for retaining the wires within the slots.

20. A post according to claim 19, wherein the outer edge of the said leg includes a lateral flange through which the slots extend, and the retaining means is engageable over the flange.

21. A post according to claim 19, wherein the outer edge portion of the leg includes projections which interact with the retaining means to engage the retaining means to the said leg.

22. A post according to claim 21, wherein the retaining means is a slide member which is applied to the said leg by being slid downwardly along the outer edge portion of the leg after engagement of the wires within the slots in the leg.

23. A post according to claim 19, wherein the stake or picket has two legs each formed with vertically-spaced generally horizontal slots opening to an outer edge of the leg for receiving the horizontal wire runs which pass through the slots in both legs.

24. A post according to claim 23, wherein separate retaining means is engageable over the outer edge of the respective leg for retaining the wires within the slots of that leg.

25. A post according to claim 23, wherein the retaining means is engageable over the outer edge of both legs to retain the wires within the slots of both legs.

26. A post according to any one of claims 23 to 25, wherein the stake or picket has three legs with the third leg being devoid of slots and constituting a main leg of the stake or picket.

27. A post for retaining horizontal wire runs of fencing wire or of wire fence mesh, the post being in the form of a stake or picket having a cross-sectional configuration formed by a plurality of legs, wherein one of the legs is bent over at its outer edge and is formed with vertically-spaced generally horizontal slots opening to the outer edge of the leg for receiving the horizontal wire runs, and a rod locatable within a void formed by the bent over portion for retaining the wires within the slots.

28. A bollard comprising a base for standing on a solid surface and carrying a picket or stake for use with a retention system according to any one of claims 1 to 4 or a picket or stake according to any one of claims 19 to 27.
